(19) United States
(12) Patent Application Publication
(10) Pub. No.: US 2026/0150090 A1
(43) Pub. Date: May 28, 2026

(54) TECHNIQUES FOR MESH INDEPENDENT CHANNEL FRONTHAUL OPTIMIZATION

(71) Applicant: QUALCOMM Incorporated, San Diego, CA (US)

(72) Inventors: Shalabh PARMAR, San Jose, CA (US); Mughilan RAMAJAYAM, Pleasanton, CA (US); Prasanthi MUPPIREDDY, San Jose, CA (US); Harsha VITTAL, Livermore, CA (US)

(21) Appl. No.: 18/957,486

(22) Filed: Nov. 22, 2024

(51) Int. Cl. H04W 72/0453

(52) U.S. Cl. CPC H04W 72/0453

(57) ABSTRACT

Methods, systems, and devices for wireless communications are described. A first access point (AP) may communicate with a second AP via a first backhaul link using a first radio that operates on a first channel within a first frequency band and via a second backhaul link using a second radio that operates on a second channel within a second frequency band. The first AP may be a controller or agent AP that operates in a centralized or decentralized network. The first AP may send the second AP a backhaul link reconfiguration message that indicates a reconfiguration of a backhaul operation, termination of the second backhaul link, and a switch to operate the second radio on a third channel within the second frequency band for fronthaul communication. The first AP or the second AP may send a fronthaul message using the second radio and based on the backhaul link reconfiguration.

### TECHNICAL FIELD

This disclosure relates generally to wireless communication and, more specifically, to techniques for mesh independent channel fronthaul optimization.

### DESCRIPTION OF THE RELATED TECHNOLOGY

Wireless communication networks may include various types of wireless communication devices including network entities (such as wireless access points (APs) or base stations (BSs)), client devices (such as wireless stations (STAs) or user equipment (UEs)), and other wireless nodes. These wireless communication devices may communicate with one another via a variety of technologies and wireless communication protocols, including wireless local area network (WLAN) or Wi-Fi-based protocols or cellular (such as 4G, 5G, or 6G)-based protocols. The wireless communication networks may be capable of supporting communication with multiple users by sharing the available system resources (such as time, frequency, and spatial resources). To enable features or provide improved performance, the wireless communication devices may employ technologies such as orthogonal frequency divisional multiple access (OFDMA), multi-user Multiple-Input Multiple-Output (MU-MIMO), spatial multiplexing, and beamforming. For greater inter-operability, the wireless communication networks may support backwards compatibility (such as supporting legacy wireless communication devices) as well as forward compatibility (such as supporting communication with wireless communication devices compatible with next-generation wireless communication standards).

### SUMMARY

The systems, methods, and devices of this disclosure each have several innovative aspects, no single one of which is solely responsible for the desirable attributes disclosed herein.

A method for wireless communications by a first access point is described. The method may include communicating with a second access point via: a first backhaul link using a first radio, of a set of multiple radios associated with the first access point, that operates on a first channel within a first frequency band, and a second backhaul link using a second radio, of the set of multiple radios, that operates on a second channel within a second frequency band, communicating, with the second access point, a backhaul link reconfiguration message indicating a reconfiguration of a backhaul operation based on expected backhaul traffic between the first access point and the second access point, and based on an expected data traffic load of one or more stations associated with the first access point, the second access point, or both, the backhaul link reconfiguration message indicating termination of the second backhaul link between the first access point and the second access point, and the backhaul link reconfiguration message indicating a switch by the first access point to operate the second radio on a third channel within the second frequency band for fronthaul communication, and transmitting, to the second access point and via the first backhaul link, a first backhaul message based on the backhaul link reconfiguration message.

A first access point for wireless communications is described. The first access point may include a processing system that includes processor circuitry and memory circuitry that stores code. The processing system may be configured to cause the first access point to communicate with a second access point via: a first backhaul link using a first radio, of a set of multiple radios associated with the first access point, that operates on a first channel within a first frequency band, and a second backhaul link using a second radio, of the set of multiple radios, that operates on a second channel within a second frequency band, communicate, with the second access point, a backhaul link reconfiguration message indicating a reconfiguration of a backhaul operation based on expected backhaul traffic between the first access point and the second access point, and based on an expected data traffic load of one or more stations associated with the first access point, the second access point, or both, the backhaul link reconfiguration message indicating termination of the second backhaul link between the first access point and the second access point, and the backhaul link reconfiguration message indicating a switch by the first access point to operate the second radio on a third channel within the second frequency band for fronthaul communication, and transmit, to the second access point and via the first backhaul link, a first backhaul message based on the backhaul link reconfiguration message.

Another first access point for wireless communications is described. The first access point may include means for communicating with a second access point via: a first backhaul link using a first radio, of a set of multiple radios associated with the first access point, that operates on a first channel within a first frequency band, and a second backhaul link using a second radio, of the set of multiple radios, that operates on a second channel within a second frequency band, means for communicating, with the second access point, a backhaul link reconfiguration message indicating a reconfiguration of a backhaul operation based on expected backhaul traffic between the first access point and the second access point, and based on an expected data traffic load of one or more stations associated with the first access point, the second access point, or both, the backhaul link reconfiguration message indicating termination of the second backhaul link between the first access point and the second access point, and the backhaul link reconfiguration message indicating a switch by the first access point to operate the second radio on a third channel within the second frequency band for fronthaul communication, and means for transmitting, to the second access point and via the first backhaul link, a first backhaul message based on the backhaul link reconfiguration message.

A non-transitory computer-readable medium storing code for wireless communications is described. The code may include instructions executable by one or more processors to communicate with a second access point via: a first backhaul link using a first radio, of a set of multiple radios associated with the first access point, that operates on a first channel within a first frequency band, and a second backhaul link using a second radio, of the set of multiple radios, that operates on a second channel within a second frequency band, communicate, with the second access point, a backhaul link reconfiguration message indicating a reconfiguration of a backhaul operation based on expected backhaul traffic between the first access point and the second access point, and based on an expected data traffic load of one or more stations associated with the first access point, the second access point, or both, the backhaul link reconfiguration message indicating termination of the second backhaul link between the first access point and the second access point, and the backhaul link reconfiguration message indicating a switch by the first access point to operate the second radio on a third channel within the second frequency band for fronthaul communication, and transmit, to the second access point and via the first backhaul link, a first backhaul message based on the backhaul link reconfiguration message.

Some examples of the method, first access points, and non-transitory computer-readable medium described herein may further include operations, features, means, or instructions for receiving, from the second access point, a second backhaul message including link information, where the backhaul link reconfiguration message may be communicated based on the link information.

In some examples of the method, first access points, and non-transitory computer-readable medium described herein, the backhaul link reconfiguration message further includes an indication a fourth channel within the second frequency band to use for fronthaul communication and the fourth channel may be different from the third channel.

Some examples of the method, first access points, and non-transitory computer-readable medium described herein may further include operations, features, means, or instructions for overlapping basic service set (OBSS) interference associated with one or more links associated with the first access point satisfying an interference threshold, a channel condition associated with one or more links associated with the first access point satisfying a channel condition threshold, available airtime associated with one or more links associated with the first access point satisfying an available airtime threshold, or any combination thereof.

Some examples of the method, first access points, and non-transitory computer-readable medium described herein may further include operations, features, means, or instructions for communicating, to the second access point, a second backhaul link reconfiguration message based on a channel condition associated with the first backhaul link satisfying a channel condition threshold, where the second backhaul link reconfiguration message indicates a second switch by the first access point to operate the second radio on the second channel within the second frequency band for backhaul communication.

In some examples of the method, first access points, and non-transitory computer-readable medium described herein, the second backhaul link operates in primary multi-link operation (P-MLO) mode or asynchronous multi-link multi-radio (AMLMR) mode.

In some examples of the method, first access points, and non-transitory computer-readable medium described herein, after the switch to operate the second radio on the third channel within the second frequency band, the first access point and the second access point operate on independent channels, within the second frequency band, for fronthaul communication.

In some examples of the method, first access points, and non-transitory computer-readable medium described herein, the first radio used for the first backhaul link may be also used for a first fronthaul link, prior to the reconfiguration of the backhaul operation, the second radio used for the second backhaul link may be also used for a second fronthaul link, and after the reconfiguration of the backhaul operation, the second radio may be dedicated for fronthaul communication.

In some examples of the method, first access points, and non-transitory computer-readable medium described herein, a third radio, of the set of multiple radios, that operates on a fifth channel within a third frequency band, where the fifth channel within the third frequency band may be used for a first fronthaul link, a fourth radio, of the set of multiple radios, that operates on a sixth channel within a fourth frequency band, where the sixth channel within the fourth frequency band may be used for a second fronthaul link, or a combination thereof.

In some examples of the method, first access points, and non-transitory computer-readable medium described herein, the first radio used for the first backhaul link may be dedicated for backhaul communication, and the third radio used for the first fronthaul link and the fourth radio used for the second fronthaul link may be dedicated for fronthaul communication, prior to the reconfiguration of the backhaul operation, the second radio used for the second backhaul link may be also used for a third fronthaul link, and after the reconfiguration of the single link backhaul operation, the second radio may be dedicated for fronthaul communication.

In some examples of the method, first access points, and non-transitory computer-readable medium described herein, the first access point may be a controller access point and the second access point may be an agent access point and the first access point may be an agent access point and the second access point may be a controller access point.

In some examples of the method, first access points, and non-transitory computer-readable medium described herein, the reconfiguration of the backhaul operation includes a transition of the backhaul operation from a first quantity of backhaul links to a second quantity of backhaul links and the second quantity of backhaul links may be less than the first quantity of backhaul links.

In some examples of the method, first access points, and non-transitory computer-readable medium described herein, the first quantity of backhaul links may be equal to a maximum quantity of multi-link operation (MLO) links for a backhaul network associated with the first access point.

A method for wireless communications by a second access point is described. The method may include communicating with a first access point via: a first backhaul link using a first radio, of a set of multiple radios associated with the second access point, that operates on a first channel within a first frequency band, and a second backhaul link using a second radio, of the set of multiple radios, that operates on a second channel within a second frequency band, communicating, with the first access point, a backhaul link reconfiguration message based on expected backhaul traffic between the first access point and the second access point, and based on an expected data traffic load of one or more stations associated with the first access point, the second access point, or both, the backhaul link reconfiguration message including a first indication of a reconfiguration of a backhaul operation, a second indication of termination of the second backhaul link between the first access point and the second access point, and a third indication of a switch by the first access point to operate on a third channel within the second frequency band for fronthaul communication, and receiving, from the second access point and via the first backhaul link, a first backhaul message based on the backhaul link reconfiguration message.

A second access point for wireless communications is described. The second access point may include a processing system that includes processor circuitry and memory circuitry that stores code. The processing system may be configured to cause the second access point to communicate with a first access point via: a first backhaul link using a first radio, of a set of multiple radios associated with the second access point, that operates on a first channel within a first frequency band, and a second backhaul link using a second radio, of the set of multiple radios, that operates on a second channel within a second frequency band, communicate, with the first access point, a backhaul link reconfiguration message based on expected backhaul traffic between the first access point and the second access point, and based on an expected data traffic load of one or more stations associated with the first access point, the second access point, or both, the backhaul link reconfiguration message including a first indication of a reconfiguration of a backhaul operation, a second indication of termination of the second backhaul link between the first access point and the second access point, and a third indication of a switch by the first access point to operate on a third channel within the second frequency band for fronthaul communication, and receive, from the second access point and via the first backhaul link, a first backhaul message based on the backhaul link reconfiguration message.

Another second access point for wireless communications is described. The second access point may include means for communicating with a first access point via: a first backhaul link using a first radio, of a set of multiple radios associated with the second access point, that operates on a first channel within a first frequency band, and a second backhaul link using a second radio, of the set of multiple radios, that operates on a second channel within a second frequency band, means for communicating, with the first access point, a backhaul link reconfiguration message based on expected backhaul traffic between the first access point and the second access point, and based on an expected data traffic load of one or more stations associated with the first access point, the second access point, or both, the backhaul link reconfiguration message including a first indication of a reconfiguration of a backhaul operation, a second indication of termination of the second backhaul link between the first access point and the second access point, and a third indication of a switch by the first access point to operate on a third channel within the second frequency band for fronthaul communication, and means for receiving, from the second access point and via the first backhaul link, a first backhaul message based on the backhaul link reconfiguration message.

A non-transitory computer-readable medium storing code for wireless communications is described. The code may include instructions executable by one or more processors to communicate with a first access point via: a first backhaul link using a first radio, of a set of multiple radios associated with the second access point, that operates on a first channel within a first frequency band, and a second backhaul link using a second radio, of the set of multiple radios, that operates on a second channel within a second frequency band, communicate, with the first access point, a backhaul link reconfiguration message based on expected backhaul traffic between the first access point and the second access point, and based on an expected data traffic load of one or more stations associated with the first access point, the second access point, or both, the backhaul link reconfiguration message including a first indication of a reconfiguration of a backhaul operation, a second indication of termination of the second backhaul link between the first access point and the second access point, and a third indication of a switch by the first access point to operate on a third channel within the second frequency band for fronthaul communication, and receive, from the second access point and via the first backhaul link, a first backhaul message based on the backhaul link reconfiguration message.

Some examples of the method, second access points, and non-transitory computer-readable medium described herein may further include operations, features, means, or instructions for transmitting, to the first access point, a second backhaul message including link information, where the backhaul link reconfiguration message may be communicated based on the link information.

In some examples of the method, second access points, and non-transitory computer-readable medium described herein, the backhaul link reconfiguration message further includes an indication a fourth channel within the second frequency band to use for fronthaul communication and the fourth channel may be different from the third channel.

Some examples of the method, second access points, and non-transitory computer-readable medium described herein may further include operations, features, means, or instructions for overlapping basic service set (OBSS) interference associated with one or more links associated with the first access point satisfying an interference threshold, a channel condition associated with one or more links associated with the first access point satisfying a channel condition threshold, available airtime associated with one or more links associated with the first access point satisfying an available airtime threshold, or any combination thereof.

Some examples of the method, second access points, and non-transitory computer-readable medium described herein may further include operations, features, means, or instructions for receiving, from the first access point and based on a channel condition associated with the first backhaul link satisfying a channel condition threshold, a second backhaul link reconfiguration message indicating a second switch by the first access point to operate on the second channel within the second frequency band for backhaul communication.

In some examples of the method, second access points, and non-transitory computer-readable medium described herein, the second backhaul link operates in primary multi-link operation (P-MLO) mode or asynchronous multi-link multi-radio (AMLMR) mode.

In some examples of the method, second access points, and non-transitory computer-readable medium described herein, after the switch by the first access point to operate on the second channel within the second frequency band for fronthaul communication, the first access point and the second access point operate on independent channels, within the second frequency band, for fronthaul communication.

In some examples of the method, second access points, and non-transitory computer-readable medium described herein, the first radio used for the first backhaul link may be also used for a first fronthaul link, prior to the reconfiguration of the backhaul operation, the second radio used for the second backhaul link may be also used for a second fronthaul link, and after the reconfiguration of the backhaul operation, the second radio may be dedicated for fronthaul communication.

In some examples of the method, second access points, and non-transitory computer-readable medium described herein, a third radio, of the set of multiple radios, that operates on a fifth channel within a third frequency band, where the fifth channel within the third frequency band may be used for a first fronthaul link, a fourth radio, of the set of multiple radios, that operates on a sixth channel within a fourth frequency band, where the sixth channel within the fourth frequency band may be used for a second fronthaul link, or a combination thereof.

In some examples of the method, second access points, and non-transitory computer-readable medium described herein, the first radio used for the first backhaul link may be dedicated for backhaul communication, and the third radio used for the first fronthaul link and the fourth radio used for the second fronthaul link may be dedicated for fronthaul communication, prior to the reconfiguration of the backhaul operation, the second radio used for the second backhaul link may be also used for a third fronthaul link, and after the reconfiguration of the backhaul operation, the second radio may be dedicated for fronthaul communication.

In some examples of the method, second access points, and non-transitory computer-readable medium described herein, the first access point may be a controller access point and the second access point may be an agent access point or and the first access point may be an agent access point and the second access point may be a controller access point.

In some examples of the method, second access points, and non-transitory computer-readable medium described herein, the reconfiguration of the backhaul operation includes a transition of the backhaul operation from a first quantity of backhaul links to a second quantity of backhaul links and the second quantity of backhaul links may be less than the first quantity of backhaul links.

In some examples of the method, second access points, and non-transitory computer-readable medium described herein, the first quantity of backhaul links may be equal to a maximum quantity of multi-link operation (MLO) links for a backhaul network associated with the second access point.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 shows a pictorial diagram of an example wireless communication network.

FIG. 2 shows an example of a porting of a wireless communication network that support techniques for mesh independent channel fronthaul optimization in accordance with one or more aspects of the present disclosure.

FIGS. 3 and 4 show example signal flows that support techniques for mesh independent channel fronthaul optimization in accordance with one or more aspects of the present disclosure.

FIGS. 5 and 6 show example wireless access point (AP) configurations that support techniques for mesh independent channel fronthaul optimization in accordance with one or more aspects of the present disclosure.

FIGS. 7 and 8 show block diagrams of devices that support techniques for mesh independent channel fronthaul optimization in accordance with one or more aspects of the present disclosure.

FIG. 9 shows a block diagram of a communications manager that supports techniques for mesh independent channel fronthaul optimization in accordance with one or more aspects of the present disclosure.

FIG. 10 shows a diagram of a system including a device that supports techniques for mesh independent channel fronthaul optimization in accordance with one or more aspects of the present disclosure.

FIGS. 11 and 12 show flowcharts illustrating methods that support techniques for mesh independent channel fronthaul optimization in accordance with one or more aspects of the present disclosure.

Like reference numbers and designations in the various drawings indicate like elements.

### DETAILED DESCRIPTION

The following description is directed to some particular examples for the purposes of describing innovative aspects of this disclosure. However, a person having ordinary skill in the art will readily recognize that the teachings herein can be applied in a multitude of different ways. Some or all of the described examples may be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G, 5G (New Radio (NR)) or 6G standards promulgated by the 3rd Generation Partnership Project (3GPP), among others.

The described examples can be implemented in any suitable device, component, system or network that is capable of transmitting and receiving RF signals according to one or more of the following technologies or techniques: code division multiple access (CDMA), time division multiple access (TDMA), orthogonal frequency division multiplexing (OFDM), frequency division multiple access (FDMA), orthogonal FDMA (OFDMA), single-carrier FDMA (SC-FDMA), spatial division multiple access (SDMA), rate-splitting multiple access (RSMA), multi-user shared access (MUSA), single-user (SU) multiple-input multiple-output (MIMO) and multi-user (MU)-MIMO (MU-MIMO). The described examples also can be implemented using other wireless communication protocols or RF signals suitable for use in one or more of a wireless personal area network (WPAN), a wireless local area network (WLAN), a wireless wide area network (WWAN), a wireless metropolitan area network (WMAN), a non-terrestrial network (NTN), or an internet of things (IOT) network.

In some wireless communication networks, multiple wireless access points (APs) may work together in a mesh network to provide a wireless connection that provides broad coverage. In the mesh network, each AP may be interconnected and may communicate with one another over one or more communication links, such as one or more backhaul links. In some cases, a controller AP may act as a central or primary management hub for the mesh network, while one or more other agent APs function under the management of the controller AP. In some cases, the controller AP may be connected to a core network (e.g., the Internet), for example, and may coordinate with the agent APs to manage the flow of data from the core network across the mesh network. The agent APs may be distributed across a geographic area to extend coverage of the mesh network over a broad area. The agent APs may act as relays, relaying data to and from the controller AP or, in some cases, other agent APs. The mesh network may further include one or more wireless stations (STAs). The one or more STAs may connect to a nearest one of the APs in the mesh network via one or more communication links, such as one or more fronthaul links.

In some wireless communication networks, a multi-link operation (MLO) may be enabled for backhaul communication at a mesh network (e.g., for Easy Mesh backhaul). The MLO may enable a controller AP to connect on multiple frequency bands (e.g., multiple radios) simultaneously for backhaul communications with an agent AP. The MLO may enable increased throughput and may reduce latency by use of the multiple links, while also providing for redundancy. In some wireless communication networks that implement MLO, one or more frequency bands (e.g., one or more radios) may be dedicated to backhaul communications or to fronthaul communications. For instance, one or more of multiple links may be a dedicated backhaul link or a dedicated fronthaul link. As an example, a first frequency band may be used by a controller AP and an agent AP as dedicated for a fronthaul link. In this case, the controller and agent APs may operate their respective fronthaul radios on different (e.g., independent) channels of the frequency band. In some cases, one or more frequency bands (e.g., shared radios) may be shared for backhaul and fronthaul communications. For instance, one or more of multiple links may be a shared backhaul and fronthaul link. As an example, a second frequency band may be used by a controller AP and an agent AP as a shared backhaul and fronthaul link. As a result, in such cases, the controller AP and the agent AP may be relegated to utilizing the same channel for both backhaul and fronthaul communications on the shared frequency band. That is, the controller AP and the agent AP may operate their respective shared radios on a given channel for backhaul communications with one another, and because the respective shared radios are also utilized for fronthaul communications, the fronthaul communications will utilize the same channel. This, in turn, may cause congestion in the network since the STAs, using the fronthaul link, and the APs, using the backhaul link, may be contending for the same medium. This may result in reduce throughput across the frequency band and increased latency at the STAs. Moreover, when the backhaul and fronthaul links operate on the same channels, overlapping basic service set (OBSS) interference at the APs may result, which may lead to a reduced amount of available airtime, thereby further negatively impacting latencies.

Various aspects relate generally to techniques for mesh independent channel fronthaul optimization. Some aspects more specifically relate to techniques that may enable individual APs in a mesh network to operate on independent channels by switching between MLO and single link operation (SLO) on the backhaul (or to a MLO having fewer backhaul links). In some examples, by switching between MLO and SLO on the backhaul, improvements at the fronthaul may be realized. For example, a switching from MLO to SLO on the backhaul may free a shared radio (e.g., a radio shared for backhaul and fronthaul communication) to serve as a radio dedicated for fronthaul communication, allowing the controller and agent APs to operate their respective radios on different (e.g., independent) channels.

For example, in some implementations, a first AP (e.g., a controller AP or an agent AP) may communicate with a second AP (e.g., an agent AP or a controller AP) via a first backhaul link and a second backhaul link. The first AP may use a first radio that operates on a first channel within a first frequency band for the first backhaul link and may use a second radio that operates on a second channel within a second frequency band for the second backhaul link. Based on backhaul traffic or a data load at one or more of STAs, the first AP may initiate a backhaul link reconfiguration that causes one of the backhaul links, such as the second backhaul link, to be decoupled (e.g. terminated) from the first AP and second AP. After decoupling the second backhaul link, the first AP may use the second radio for fronthaul communication. For example, the first AP may switch the second radio to operate on a different channel, such as a third channel, within the second frequency band for the fronthaul communications. The first AP may send the second AP a link reconfiguration message notifying of the switch to the third channel within the second frequency band for fronthaul communication. In some cases, the link reconfiguration message may include an indication of a fourth channel within the second frequency band that the second AP should use for fronthaul communication, and the fourth channel may be different from the third channel. Thereafter, the first AP may communicate one or more fronthaul messages using its second radio operating on the third channel within the second frequency band and the second AP may communicate one or more fronthaul messages using its own second radio operating on the fourth channel within the second frequency band. The first AP and the second AP may communicate one or more backhaul messages via the first backhaul link.

Particular aspects of the subject matter described in this disclosure can be implemented to realize one or more of the following potential advantages. In some examples, by transitioning from MLO that utilizes a first quantity of backhaul links to SLO, or other MLO that utilizes a second quantity of backhaul links that is less than the first quantity of backhaul links, the described techniques may be used to enable a previously shared (e.g., shared for backhaul and fronthaul communications) radio to be freed up for fronthaul communication. This may enable a first AP and a second AP to operate their respective previously-shared radios on different (e.g., independent) channels for fronthaul communications, thereby increasing airtime and reducing OBSS interference. This in turn may reduce latency (e.g., particularly for sensitive applications) at the one or more STAs and may improve throughput at the network. Further, admission control may admit more service level agreement (SLA) flows to prioritized queues, rather than rejecting them due to the shared bandwidth between fronthaul and backhaul.

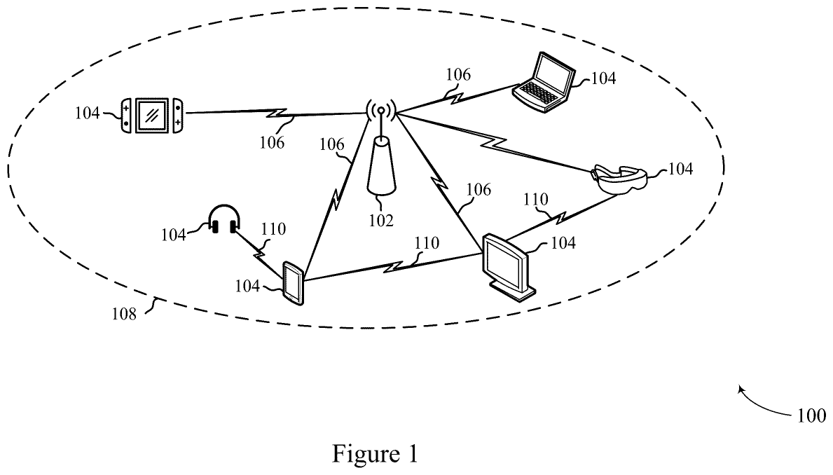

FIG. 1 shows a pictorial diagram of an example wireless communication network 100. According to some aspects, the wireless communication network 100 can be an example of a wireless local area network (WLAN) such as a Wi-Fi network. For example, the wireless communication network 100 can be a network implementing at least one of the IEEE 802.11 family of wireless communication protocol standards, such as defined by the IEEE 802.11-2020 specification or amendments thereof (including, but not limited to, 802.11ay, 802.11ax (also referred to as Wi-Fi 6), 802.11az, 802.11ba, 802.11bc, 802.11bd, 802.11be (also referred to as Wi-Fi 7), 802.11bf, and 802.11bn (also referred to as Wi-Fi 8)) or other WLAN or Wi-Fi standards, such as that associated with the Integrated Millimeter Wave (IMMW) study group. In some other examples, the wireless communication network 100 can be an example of a cellular radio access network (RAN), such as a 5G or 6G RAN that implements one or more cellular protocols such as those specified in one or more 3GPP standards. In some other examples, the wireless communication network 100 can include a WLAN that functions in an interoperable or converged manner with one or more cellular RANs to provide greater or enhanced network coverage to wireless communication devices within the wireless communication network 100 or to enable such devices to connect to a cellular network's core, such as to access the network management capabilities and functionality offered by the cellular network core. In some other examples, the wireless communication network 100 can include a WLAN that functions in an interoperable or converged manner with one or more personal area networks, such as a network implementing Bluetooth or other wireless technologies, to provide greater or enhanced network coverage or to provide or enable other capabilities, functionality, applications or services.

The wireless communication network 100 may include numerous wireless communication devices including a wireless AP 102 and any number of STAs 104. While only one AP 102 is shown in FIG. 1, the wireless communication network 100 can include multiple APs 102 (for example, in an extended service set (ESS) deployment, enterprise network or AP mesh network), or may not include any AP at all (for example, in an independent basic service set (IBSS) such as a peer-to-peer (P2P) network or other ad hoc network). The AP 102 can be or represent various different types of network entities including, but not limited to, a home networking AP, an enterprise-level AP, a single-frequency AP, a dual-band simultaneous (DBS) AP, a tri-band simultaneous (TBS) AP, a standalone AP, a non-standalone AP, a software-enabled AP (soft AP), and a multi-link AP (also referred to as an AP multi-link device (MLD)), as well as cellular (such as 3GPP, 4G LTE, 5G or 6G) base stations or other cellular network nodes such as a Node B, an evolved Node B (eNB), a gNB, a transmission reception point (TRP) or another type of device or equipment included in a radio access network (RAN), including Open-RAN (O-RAN) network entities, such as a central unit (CU), a distributed unit (DU) or a radio unit (RU).

Each of the STAs 104 also may be referred to as a mobile station (MS), a mobile device, a mobile handset, a wireless handset, an access terminal (AT), a user equipment (UE), a subscriber station (SS), or a subscriber unit, among other examples. The STAs 104 may represent various devices such as mobile phones, other handheld or wearable communication devices, netbooks, notebook computers, tablet computers, laptops, Chromebooks, augmented reality (AR), virtual reality (VR), mixed reality (MR) or extended reality (XR) wireless headsets or other peripheral devices, wireless earbuds, other wearable devices, display devices (for example, TVs, computer monitors or video gaming consoles), video game controllers, navigation systems, music or other audio or stereo devices, remote control devices, printers, kitchen appliances (including smart refrigerators) or other household appliances, key fobs (for example, for passive keyless entry and start (PKES) systems), Internet of Things (IoT) devices, and vehicles, among other examples.

A single AP 102 and an associated set of STAs 104 may be referred to as an infrastructure basic service set (BSS), which is managed by the respective AP 102. FIG. 1 additionally shows an example coverage area 108 of the AP 102, which may represent a basic service area (BSA) of the wireless communication network 100. The BSS may be identified by STAs 104 and other devices by a service set identifier (SSID), as well as a basic service set identifier (BSSID), which may be a medium access control (MAC) address of the AP 102. The AP 102 may periodically broadcast beacon frames (“beacons”) including the BSSID to enable any STAs 104 within wireless range of the AP 102 to “associate” or re-associate with the AP 102 to establish a respective communication link 106 (hereinafter also referred to as a “Wi-Fi link”), or to maintain a communication link 106, with the AP 102. For example, the beacons can include an identification or indication of a primary channel used by the respective AP 102 as well as a timing synchronization function (TSF) for establishing or maintaining timing synchronization with the AP 102. The AP 102 may provide access to external networks to various STAs 104 in the wireless communication network 100 via respective communication links 106.

To establish a communication link 106 with an AP 102, each of the STAs 104 is configured to perform passive or active scanning operations (“scans”) on frequency channels in one or more frequency bands (for example, the 2.4 GHz, 5 GHz, 6 GHz, 45 GHz, or 60 GHz bands). To perform passive scanning, a STA 104 listens for beacons, which are transmitted by respective APs 102 at periodic time intervals referred to as target beacon transmission times (TBTTs). To perform active scanning, a STA 104 generates and sequentially transmits probe requests on each channel to be scanned and listens for probe responses from APs 102. Each STA 104 may identify, determine, ascertain, or select an AP 102 with which to associate in accordance with the scanning information obtained through the passive or active scans, and to perform authentication and association operations to establish a communication link 106 with the selected AP 102. The selected AP 102 assigns an association identifier (AID) to the STA 104 at the culmination of the association operations, which the AP 102 uses to track the STA 104.

As a result of the increasing ubiquity of wireless networks, a STA 104 may have the opportunity to select one of many BSSs within range of the STA 104 or to select among multiple APs 102 that together form an ESS including multiple connected BSSs. For example, the wireless communication network 100 may be connected to a wired or wireless distribution system that may enable multiple APs 102 to be connected in such an ESS. As such, a STA 104 can be covered by more than one AP 102 and can associate with different APs 102 at different times for different transmissions. Additionally, after association with an AP 102, a STA 104 also may periodically scan its surroundings to find a more suitable AP 102 with which to associate. For example, a STA 104 that is moving relative to its associated AP 102 may perform a “roaming” scan to find another AP 102 having more desirable network characteristics such as a greater received signal strength indicator (RSSI) or a reduced traffic load.

In some examples, STAs 104 may form networks without APs 102 or other equipment other than the STAs 104 themselves. One example of such a network is an ad hoc network (or wireless ad hoc network). Ad hoc networks may alternatively be referred to as mesh networks or P2P networks. In some examples, ad hoc networks may be implemented within a larger network such as the wireless communication network 100. In such examples, while the STAs 104 may be capable of communicating with each other through the AP 102 using communication links 106, STAs 104 also can communicate directly with each other via direct wireless communication links 110. Additionally, two STAs 104 may communicate via a direct wireless communication link 110 regardless of whether both STAs 104 are associated with and served by the same AP 102. In such an ad hoc system, one or more of the STAs 104 may assume the role filled by the AP 102 in a BSS. Such a STA 104 may be referred to as a group owner (GO) and may coordinate transmissions within the ad hoc network. Examples of direct wireless communication links 110 include Wi-Fi Direct connections, connections established by using a Wi-Fi Tunneled Direct Link Setup (TDLS) link, and other P2P group connections.

In some networks, the AP 102 or the STAs 104, or both, may support applications associated with high throughput or low-latency requirements, or may provide lossless audio to one or more other devices. For example, the AP 102 or the STAs 104 may support applications and use cases associated with ultra-low-latency (ULL), such as ULL gaming, or streaming lossless audio and video to one or more personal audio devices (such as peripheral devices) or AR/VR/MR/XR headset devices. In scenarios in which a user uses two or more peripheral devices, the AP 102 or the STAs 104 may support an extended personal audio network enabling communication with the two or more peripheral devices. Additionally, the AP 102 and STAs 104 may support additional ULL applications such as cloud-based applications (such as VR cloud gaming) that have ULL and high throughput requirements.

As indicated above, in some implementations, the AP 102 and the STAs 104 may function and communicate (via the respective communication links 106) according to one or more of the IEEE 802.11 family of wireless communication protocol standards. These standards define the WLAN radio and baseband protocols for the physical (PHY) and MAC layers. The AP 102 and STAs 104 transmit and receive wireless communications (hereinafter also referred to as “Wi-Fi communications” or “wireless packets”) to and from one another in the form of PHY protocol data units (PPDUs).

Each PPDU is a composite structure that includes a PHY preamble and a payload that is in the form of a PHY service data unit (PSDU). The information provided in the preamble may be used by a receiving device to decode the subsequent data in the PSDU. In instances in which a PPDU is transmitted over a bonded or wideband channel, the preamble fields may be duplicated and transmitted in each of multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is associated with the particular IEEE 802.11 wireless communication protocol to be used to transmit the payload.

The APs 102 and STAs 104 in the wireless communication network 100 may transmit PPDUs over an unlicensed spectrum, which may be a portion of spectrum that includes frequency bands traditionally used by Wi-Fi technology, such as the 2.4 GHz, 5 GHz, 6 GHz, 45 GHz, and 60 GHz bands. Some examples of the APs 102 and STAs 104 described herein also may communicate in other frequency bands that may support licensed or unlicensed communications. For example, the APs 102 or STAs 104, or both, also may be capable of communicating over licensed operating bands, where multiple operators may have respective licenses to operate in the same or overlapping frequency ranges. Such licensed operating bands may map to or be associated with frequency range designations of FR1 (410 MHz-7.125 GHz), FR2 (24.25 GHz-52.6 GHz), FR3 (7.125 GHz-24.25 GHz), FR4a or FR4-1 (52.6 GHz-71 GHz), FR4 (52.6 GHz-114.25 GHz), and FR5 (114.25 GHz-300 GHz).

Each of the frequency bands may include multiple sub-bands and frequency channels (also referred to as subchannels). The terms “channel” and “subchannel” may be used interchangeably herein, as each may refer to a portion of frequency spectrum within a frequency band (for example, a 20 MHz, 40 MHz, 80 MHz, or 160 MHz portion of frequency spectrum) via which communication between two or more wireless communication devices can occur. For example, PPDUs conforming to the IEEE 802.11n, 802.11ac, 802.11ax, 802.11be and 802.11bn standard amendments may be transmitted over one or more of the 2.4 GHz, 5 GHz, or 6 GHz bands, each of which is divided into multiple 20 MHz channels. As such, these PPDUs are transmitted over a physical channel having a minimum bandwidth of 20 MHz, but larger channels can be formed through channel bonding. For example, PPDUs may be transmitted over physical channels having bandwidths of 40 MHz, 80 MHz, 160 MHz, 240 MHz, 320 MHz, 480 MHz, or 640 MHz by bonding together multiple 20 MHz channels.

An AP 102 may determine or select an operating or operational bandwidth for the STAs 104 in its BSS and select a range of channels within a band to provide that operating bandwidth. For example, the AP 102 may select sixteen 20 MHz channels that collectively span an operating bandwidth of 320 MHz. Within the operating bandwidth, the AP 102 may typically select a single primary 20 MHz channel on which the AP 102 and the STAs 104 in its BSS monitor for contention-based access schemes. In some examples, the AP 102 or the STAs 104 may be capable of monitoring only a single primary 20 MHz channel for packet detection (for example, for detecting preambles of PPDUs). Conventionally, any transmission by an AP 102 or a STA 104 within a BSS must involve transmission on the primary 20 MHz channel. As such, in conventional systems, the transmitting device must contend on and win a TXOP on the primary channel to transmit anything at all. However, some APs 102 and STAs 104 supporting ultra-high reliability (UHR) communications or communication according to the IEEE 802.11bn standard amendment can be configured to operate, monitor, contend and communicate using multiple primary 20 MHz channels. Such monitoring of multiple primary 20 MHz channels may be sequential such that responsive to determining, ascertaining or detecting that a first primary 20 MHz channel is not available, a wireless communication device may switch to monitoring and contending using a second primary 20 MHz channel. Additionally, or alternatively, a wireless communication device may be configured to monitor multiple primary 20 MHz channels in parallel. In some examples, a first primary 20 MHz channel may be referred to as a main primary (M-Primary) channel and one or more additional, second primary channels may each be referred to as an opportunistic primary (O-Primary) channel. For example, if a wireless communication device measures, identifies, ascertains, detects, or otherwise determines that the M-Primary channel is busy or occupied (such as due to an overlapping BSS (OBSS) transmission), the wireless communication device may switch to monitoring and contending on an O-Primary channel. In some examples, the M-Primary channel may be used for beaconing and serving legacy client devices and an O-Primary channel may be specifically used by non-legacy (for example, UHR-or IEEE 802.11bn-compatible) devices for opportunistic access to spectrum that may be otherwise under-utilized.

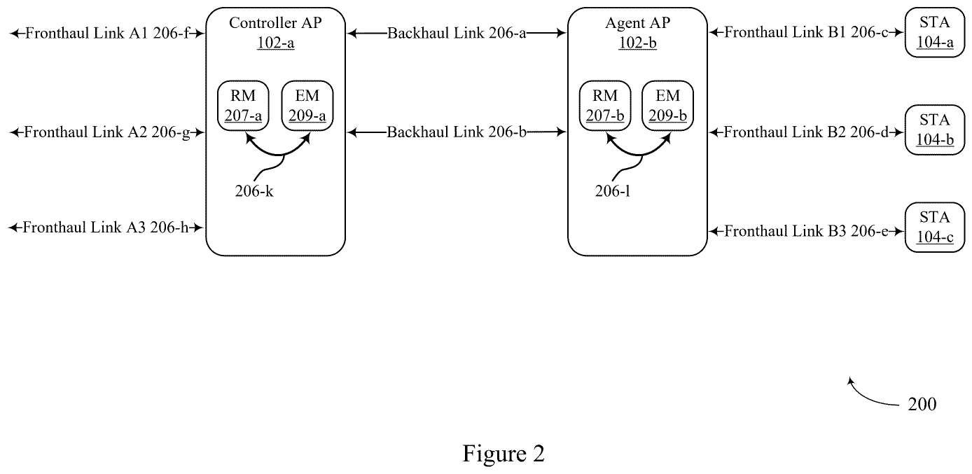

FIG. 2 shows an example of a portion of a wireless communication network 200 that supports techniques for mesh independent channel fronthaul optimization in accordance with one or more aspects of the present disclosure. In some examples, the wireless communication network 200 may be a mesh network (e.g., an Easy Mesh network) the implements MLO at the backhaul. The wireless communication network 200 may implement or be implemented by aspects of the wireless communication network 100 described with reference to FIG. 1. For example, the wireless communication network 200 may include a wireless device a first AP, such as a controller AP 102-a, a second AP, such as an agent AP 102-b, and one or more STAs 104, such as a first STA 104-a, a second STA 104-b, and a third STA 104-c, which may be examples of corresponding devices described with reference to FIG. 1. Each of the controller AP 102-a and the agent AP 102-b may include a resource manager (RM) 207 and an Easy Mesh (EM) controller 209. For instance, the controller AP 102-a may include a RM controller 207-a and an EM controller 209-a and the agent AP 102-b may include an RM controller 207-b and an EM controller 209-b. The RM controller 207-a and the EM controller 209-a may communicate one or more telemetry messages to the other via a communication link 206, such as via a communication link 206-k. The RM controller 207-b and the EM controller 209-b may communicate one or more telemetry messages to the other via a communication link 206, such as via a communication link 206-l. The controller AP 102-a and the agent AP 102-b may communicate via one or more communication links 206, such as via a first backhaul link 206-a and a second backhaul link 206-b. In some examples, the controller AP 102-a and the agent AP 102-b may communicate via one or more additional backhaul links. The agent AP 102-b may communicate with the STAs 104-a, 104-b, and 104-c via one or more communication links 206, such as via a fronthaul link B1 206-c, a fronthaul link B2 206-d, and a fronthaul link B3 206-e, respectively. The controller AP 102-a may communicate with one or more other STAs 104 via one or more communication links 206, such as via a fronthaul link A1 206-f, a fronthaul link A2 206-g, and a fronthaul link A3 206-h. In some examples, the controller AP 102-a, the agent AP 102-b, or both may communicate with a different quantity of STAs via a different quantity of fronthaul links. The communication links 206 may be examples of the communication links 106 described with reference to FIG. 1.

In some implementations, the wireless communication network 200 may operate each of the first backhaul link 206-a and the second backhaul link 206-b on a channel that is shared with a fronthaul link. For instance, the controller AP 102-a and the agent AP 102-b may use a respective first radio operating on a first channel within a first frequency band to communicate backhaul messages via the first backhaul link 206-a. The controller AP 102-a may operate the fronthaul link A1 206-f on the same channel as the backhaul link 206-a (e.g., on the first channel within the first frequency band), and the agent AP 102-b may also operate the fronthaul link B1 206-c on the same channel as the first backhaul link 206-a. Accordingly, the fronthaul link A1 206-f and the fronthaul link B1 206-c may operate on the same channel as the first backhaul link 206-a.

Further, the controller AP 102-a and the agent AP 102-b may, additionally, use a respective second radio operating on a second channel within a second frequency band to communicate backhaul messages via the second backhaul link. The controller AP 102-a may operate the second fronthaul link A2 206-g on the same channel as the second backhaul link 206-b (e.g., on the second channel within the second frequency band), and the agent AP 102-b may also operate its fronthaul link B2 206-d on the same channel as the second backhaul link 206-b. Accordingly, the fronthaul link A2 206-g and the fronthaul link B2 206-d may operate on the same channel as the second backhaul link 206-b.

In some cases, the controller AP 102-a and the agent AP 102-b may, additionally, each operate a respective dedicated fronthaul link, such as fronthaul link A3 206-h and fronthaul link B3 206-e, respectively. The dedicated fronthaul links A3 206-h and B3 206-e may operate on different (e.g., independent) channels within a third frequency band that is dedicated to fronthaul communication.

In some cases, operating the fronthaul links A1 206-f and B1 206-c on the same channel as the first backhaul link 206-a, or operating the fronthaul links A2 206-g and B2 206-d on the same channel as the second backhaul link 206-b may cause OBSS interference at the controller AP 102-a or the agent AP 102-b, congestion in the wireless communication network 200, or both, as a result of the APs 102 and STAs 104 contending for the same resources. This, in turn, may reduce throughput and an amount of available airtime, and may increase latency at the STAs 104.

In some cases, the RM controllers 207 operating at the controller AP 102-a or the agent AP 102-b may monitor the wireless communication network 200 (e.g., AP radios or channels) to manage backhaul traffic and data traffic load (among other functions). One or more of the RM controllers 207 may determine, based on the backhaul traffic (or expected backhaul traffic) or a data traffic load (or expected data traffic load), whether a single backhaul link may be sufficient to support the backhaul traffic (e.g., based on requirements of the agent AP 102-b). For instance, the RM controller 207 may determine whether the backhaul traffic satisfies a backhaul traffic threshold. If the backhaul traffic threshold is satisfied, the corresponding AP 102 may determine to reconfigure the backhaul from MLO to SLO (or to a MLO with fewer backhaul links). This may allow the AP 102 to decouple at least one of the backhaul links 206-a or 206-b from the controller AP 102-a and the agent AP 102-b and enable the corresponding radio (e.g., the previously-shared radio) to be freed up from backhaul communication and to, instead, be dedicated for fronthaul communication. In this way, the controller AP 102-a and the agent AP 102-b may operate on two separate (e.g., independent) channels within a corresponding frequency band for fronthaul communication—reducing OBSS interference and increasing available airtime.

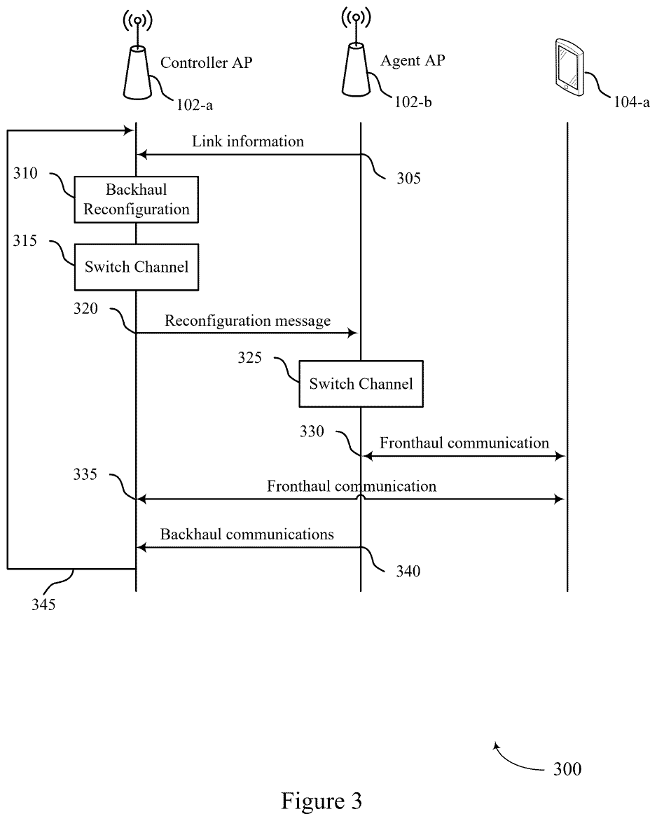

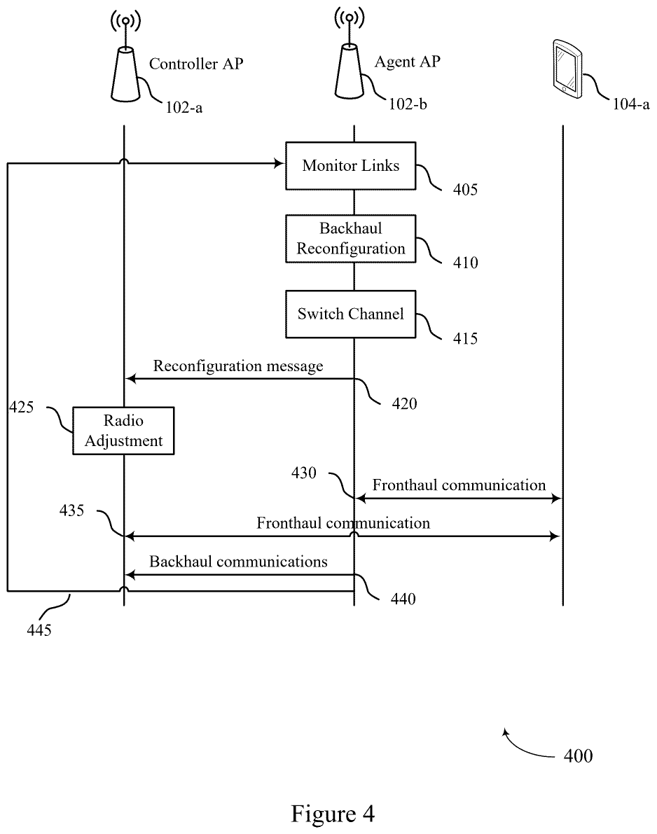

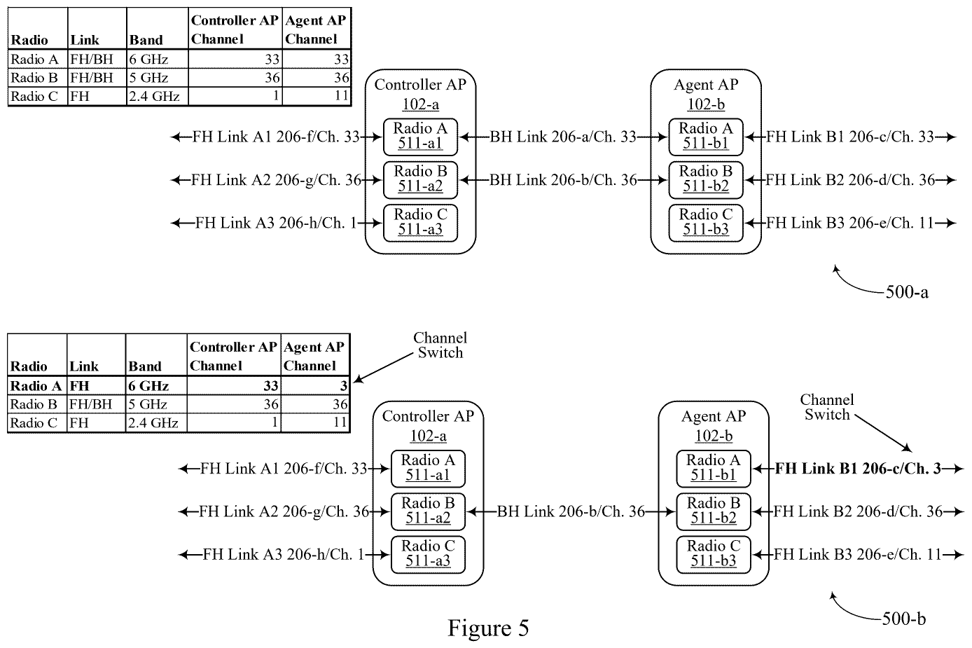

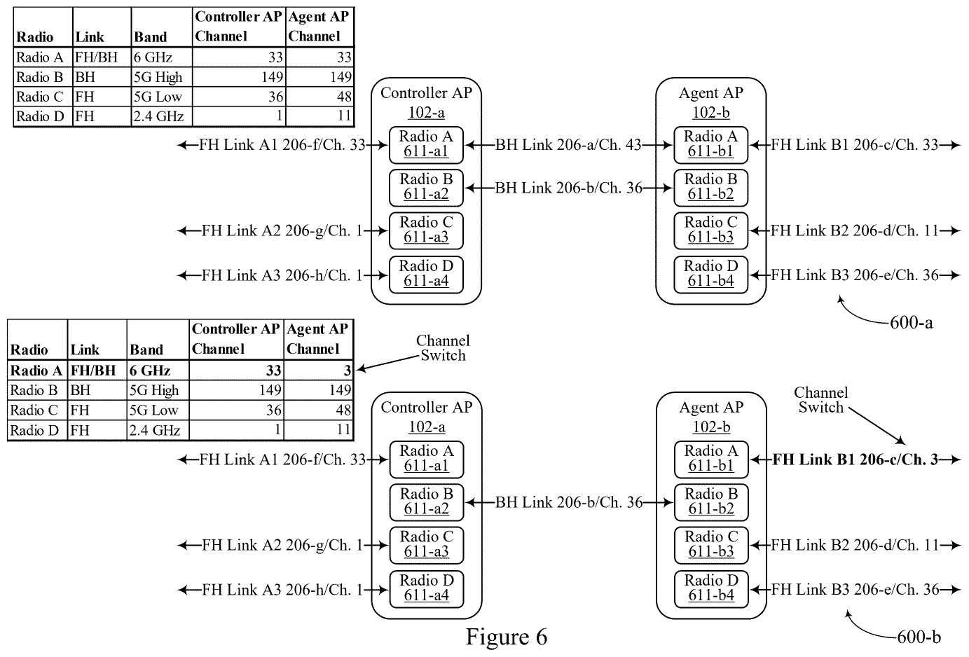

FIGS. 3 and 4 show examples of signal flows 300 and 400 that support techniques for mesh independent channel fronthaul optimization in accordance with one or more aspects of the present disclosure. In some examples, signal flows 300 and 400 may implement aspects of or may be implemented by aspects of wireless communication networks 100 and 200 described with reference to FIGS. 1 and 2. Signal flows 300 and 400 may be implemented by the controller AP 102-a, the agent AP 102-b, and one or more STAs, such as STA 104-a described with reference to FIG. 2. In the following description of the signal flows 300 and 400, the communications between the various entities may be performed in different orders or at different times. Some operations may also be omitted from either of the signal flows 300 and 400, and other operations may be added to either of the signal flows 300 and 400. In some examples, the operations illustrated in signal flows 300 and 400 may be performed by hardware (e.g., including circuitry, processing blocks, logic components, and other components), code (e.g., software or firmware) executed by a processor, or any combination thereof. Alternative examples of the signal flows 300 and 400 may be implemented, where some steps may be performed in a different order than described or may not be performed at all. In some examples, steps may include additional features not mentioned below, or further steps may be added. In some cases, the signal flows 300 and 400 may be described with reference to the AP configurations shown in FIGS. 5 and 6.

FIGS. 5 and 6 show examples of AP configurations 500 (e.g., AP configurations 500-a and 500-b) and 600 (e.g., AP configurations 600-a and 600-b) that support techniques for mesh independent channel fronthaul optimization in accordance with one or more aspects of the present disclosure. In some examples, AP configurations 500 and 600 may implement or be implemented by aspects of wireless communication networks 100 and 200 or signal flows 300 and 400 described with reference to FIGS. 1 to 4. AP configurations 500 and 600 may be example configurations of the controller AP 102-a, the agent AP 102-b, and the fronthaul links and backhaul links 206 as described with reference to FIG. 2.

AP configurations 500 may be configuration in which the controller AP 102-a and the agent AP 102-b implement 3 radios 511. The AP configuration 500-a may be a configuration of the controller AP 102-a, the agent AP 102-b, and the backhaul and fronthaul links 206 prior to a backhaul reconfiguration, and AP configuration 500-b may be a configuration of the controller AP 102-a, the agent AP 102-b, and the backhaul and fronthaul links 206 after the backhaul reconfiguration. As shown in AP configuration 500-a, the controller AP 102-a may implement radio A 511-a1, radio B 511-a2, and radio C 511-a3 and the agent AP 102-b may implement radio A 511-b1, radio B 511-b2, and radio C 511-b3. The radios A 511-a and 511-b1 and radios B 511-a2 and 511-b2 may be shared radios used for both fronthaul and backhaul communications, and the radios C 511-a3 and 511-b3 may be radios dedicated for fronthaul communications, such as described with reference to FIG. 2. In the example of AP configuration 500-a, the radios A 511-a1 and 511-b1 may operate on channel 33 within a 6 GHz frequency band to communicate fronthaul and backhaul communications, the radios B 511-a2 and 511-b2 may operate on channel 36 within a 5GHz frequency band to communicate fronthaul and backhaul communications, and the radios C 511-a3 and 511-b3 may each operate on separate (e.g., independent) channels, such as channel 1 and channel 11, respectively, within a 2.4 GHz frequency band to communicate fronthaul communications.

AP configurations 600 may be configurations in which the controller AP 102-a and the agent AP 102-b implement 4 radios 611. The AP configuration 600-a may be a configuration of the controller AP 102-a, the agent AP 102-b, and the backhaul and fronthaul links 206 prior to a backhaul reconfiguration, and AP configuration 600-b may be a configuration of the controller AP 102-a, the agent AP 102-b, and the backhaul and fronthaul links 206 after the backhaul reconfiguration. As shown in AP configuration 600-b, the controller AP 102-a may implement radio A 611-a1, radio B 611-a2, radio C 611-a3, and radio D 611-a4 and the agent AP 102-b may implement radio A 611-b1, radio B 611-b2, radio C 611-b3, and radio D 611-b4. The radios A 611-a1 and 611-b1 may be shared radios used for both fronthaul and backhaul communications, the radios B 611-a2 and 611-b2 may be radios dedicated for backhaul communications, and the radios C 511-a3 and 511-b3 and radios D 611-a4 and 611-b4 may be radios dedicated for fronthaul communications. In the example of signal flow 600-a, the radios A 611-a1 and 611-b1 may operate on channel 33 within a 6 GHz frequency band to communicate fronthaul and backhaul communications, the radios B 611-a2 and 611-b2 may operate on channel 149 within a 5G High frequency band to communicate backhaul communications, the radios C 611-a3 and 611-b3 may each operate on separate channels, such as channel 36 and channel 48, respectively, within a 5G Low frequency band to communicate fronthaul communications, and the radios D 611-a4 and 611-b4 may each operate on separate channels, such as channel 1 and channel 11, respectively, within a 2.4 GHz frequency band to communicate fronthaul communications.

Referring to FIG. 3, the signal flow 300 may reflect a flow of signals in the case where the wireless communication network (e.g., the wireless communication networks 100 or 200) operates as a centralized network, in which the controller AP 102-a may control reconfiguration of backhaul to transition the backhaul from a MLO that utilizes a first quantity of backhaul links (e.g., N backhaul links) to an SLO, or to an MLO that utilizes a second quantity of backhaul links that is less than the first quantity of backhaul links (e.g., N-1 backhaul links).

At 305, the agent AP 102-b may monitor conditions associated with one or more of the backhaul and fronthaul links 206 and may send associated link information to the controller AP 102-a. For instance, an RM controller operating at the agent AP 102-b, such as the RM controller 207-b described with reference to FIG. 2, may send to a local EM controller operating at the agent AP 102-b, such as the EM controller 209-b described with reference to FIG. 2, link information associated with the agent AP 102-b. Based on receiving the link information, the EM controller 209-b may send the link information to an EM controller operating at the controller AP 102-a, such as the EM controller 209-a. For instance, in some cases, the EM controller 209-b may send the EM controller 209-a an EM 1905 telemetry message including the link information. The EM controller 209-b may send the EM 1905 telemetry message to the EM controller 209-a via one or more of the backhaul links 206-a or 206-b. The EM controller 209-a may receive the link information and may send the link information to a local RM controller operating at the controller AP 102-a, such as the RM controller 207-a. In some cases, the link information may provide an indication of backhaul traffic (or expected backhaul traffic) associated with the first backhaul link 206-a or the second backhaul link 206-b. In some cases, the link information may provide an indication of a data traffic load associated with one or more STAs that the agent AP 102-b communicates with via the fronthaul link B1 206-c, the fronthaul link B2 206-d, or the fronthaul link B3 206-e.

At 310, based on receiving the link information from the agent AP 102-b, the controller AP 102-a, such as the RM controller 207-a operating at the controller AP 102-a, may determine whether to reconfigure backhaul to transition from a MLO that utilizes a first quantity of backhaul links (e.g., N backhaul links) to an SLO, or to an MLO that utilizes a second quantity of backhaul links 206 that is less than the first quantity of backhaul links 206 (e.g., N-1 backhaul links). For instance, the controller AP 102-a may determine whether the link information satisfies a threshold (e.g., whether the backhaul traffic, the data traffic load, or both satisfy a threshold). In some cases, the controller AP 102-a may additionally, or alternatively, determine whether OBSS associated with one or more of the backhaul or fronthaul links 206 satisfies an interference threshold, whether a channel condition associated with one or more of the backhaul or fronthaul links 206 satisfying a channel condition threshold, whether an amount of available airtime associated with one or more of the backhaul or fronthaul links 206 satisfies an available airtime threshold, or any combination thereof.

Based on whether the link information or additional information satisfies one or more of the thresholds, the controller AP 102-a may determine whether fewer backhaul links may be sufficient to support the backhaul traffic. If fewer backhaul links are determined to be sufficient to support the backhaul traffic, the controller AP 102-a may perform a reconfiguration of the backhaul to transition from a MLO that utilizes a first quantity of backhaul links (e.g., 2 backhaul links) to an SLO (e.g., 1 backhaul link), or to an MLO that utilizes a second quantity of backhaul links 206 that is less than the first quantity of backhaul links 206. Accordingly, reconfiguring the backhaul may involve the controller AP 102-a decoupling (e.g., terminating, deleting, etc.) one of backhaul links 206 that operates on a channel shared for fronthaul communications (e.g., the first backhaul links 206-a or the second backhaul links 206-b) from the controller AP 102-a and the agent AP 102-b. For instance, as shown in the AP configurations 500-b and 600-b of FIGS. 5 and 6, the controller AP 102-a may decouple the first backhaul link 206-a from the controller AP 102-a and the agent AP 102-b (the controller AP 102-a may decouple any one of the backhaul links and is not limited to decoupling the first backhaul link 206-a). In some cases, the controller AP 102-a may configure its backhaul traffic over a preferred backhaul link 206, and the controller AP 102-a, accordingly, may decouple a non-preferred backhaul link 206 in that case. By decoupling one of backhaul links 206 (e.g., the first backhaul link 206-a) that operated on a shared channel (e.g., channel 33 of the 6 GHz frequency band), using a shared radio (e.g., the radios A 511-a1 and 511-b1 for radios A 611-a1 and 611-b1), the previously-shared radio may be freed up for dedicated fronthaul communications. This may enable the controller AP 102-a and the agent AP 102-b to operate their respective previously-shared radios (e.g., the radios A 511-a1 and 511-b1 for radios A 611-a1 and 611-b1) on different (e.g., independent) channels for fronthaul communications, thereby increasing available airtime and reducing OBSS interference. This in turn may reduce latency at one or more associated STAs and may improve throughput at the network (e.g., the wireless communication networks 100 or 200).

At 315, the controller AP 102-a (e.g., the RM controller 207-a of the controller AP 102-a) may switch its previously-shared radio 511 or 611 to operate on a different channel for fronthaul communications. That is, the controller AP 102-a may switch its radio A 511-a1 or radio A 611-a1, which was previously coupled to the first backhaul link 206-a, to a different channel for dedicated fronthaul communication. In some cases, the controller AP 102-a might not switch its radio A 511-a1 or 611-a1 to a different channel and may, instead, identify another channel (different from the one the controller AP 102-a is operating on) for the agent AP 102-b to operate its radio A 511-b1 or 611-b1 on for fronthaul communications, and may instruct the agent AP 102-b accordingly (described below). In other cases, the controller AP 102-a may both switch its radio A 511-a1 or 611-a1 to a different channel for fronthaul communications and may instruct the agent AP 102-b to switch its radio A 511-b1 or 611-b1 to yet another different channel for fronthaul communications. By switching its own radio A 511-a1 or 611-a1 to a different channel or by instructing the agent AP 102-b to switch its radio A 511-b1 or 611-b1 to another channel for fronthaul communications, the controller AP 102-a and the agent AP 102-b may operate on different channels (e.g., with the same frequency band) for independent fronthaul operation. This may enable a reduction in OBSS interference and increase in available airtime, thus, reducing latency at one or more associated STAs and may improve throughput at the network (e.g., the wireless communication networks 100 or 200).

At 320, the controller AP 102-a (e.g., the EM controller 209-a of the controller AP 102-a) may transmit a backhaul reconfiguration message to the agent AP 102-b. The backhaul reconfiguration message may include an indication of the reconfiguration of backhaul by the controller AP 102-a to transition the backhaul from a MLO that utilizes a first quantity of backhaul links (e.g., N backhaul links) to an SLO, or to an MLO that utilizes a second quantity of backhaul links 206 that is less than the first quantity of backhaul links 206 (e.g., N-1 backhaul links). In some cases, the backhaul reconfiguration message may include an indication of the particular backhaul link 206 that was decoupled (e.g., terminated, deleted, etc.) from the controller AP 102-a and the agent AP 102-b. In some cases, the backhaul reconfiguration message may include an indication that the controller AP 102-a switched its radio A 511-a1 or radio A 611-a1, which was previously coupled to the first backhaul link 206-a, to operate on a different channel for dedicated fronthaul communication. In some cases, the backhaul reconfiguration message may include an indication of the new (e.g., different) channel that the controller AP 102-a operates its radio A 511-a1 or radio A 611-a1 on for the fronthaul communications. In some cases, the backhaul reconfiguration message may include an indication of a different channel for the agent AP 102-b to operate its radio A 511-b1 or radio A 611-b1 on for the fronthaul communications. The EM controller 209-a operating at the controller AP 102-a may send an EM 1905 telemetry message including the backhaul reconfiguration message. The EM controller 209-a may send the EM 1905 telemetry message to the EM controller 209-b operating at the agent AP 102-b via one of the remaining the backhaul links 206, such as the second backhaul link 206-b. The EM controller 209-b may receive the backhaul reconfiguration message and send the message to the RM controller 207-b operating at the agent AP 102-b.

At 325, based on receiving the backhaul reconfiguration message, the agent AP 102-b (e.g., the RM controller 207-b operating at the agent AP 102-b) may switch its radio A 511-b1 or radio A 611-b1, which was previously coupled to the first backhaul link 206-a, to operate on a different channel for dedicated fronthaul communication. For instance, the agent AP 102-b may switch its radio A 511-b1 or radio A 611-b1 to a channel indicated in the backhaul reconfiguration message for the agent AP 102-b to switch to. For example, as shown in AP configurations 500-b and 600-b of FIGS. 5 and 6, the agent AP 102-b may switch its radio A 511-b1 or radio A 611-b1 to channel 3 for fronthaul communications, thereby enabling the controller AP 102-a and the agent AP 102-b to operate their respective radios A 511 or 611 on different channels for fronthaul communications.

At 330, 335, and 340, based on the backhaul reconfiguration, the controller AP 102-a, the agent AP 102-b, or both may, thereafter, communicate fronthaul communications to one or more STAs, such as a first STA 104-a, by operating their respective radios A on different (e.g., independent) channels, and may communicate backhaul communications between one another on the remaining second backhaul link 206-b. For example, as shown in AP configuration 500-b, the controller AP 102-a may operate its radio A 511-a1 on channel 33 within the 6 GHz frequency band for dedicated fronthaul communications, while the agent AP 102-b may operate its radio A 511-b1 on channel 3 within the 6 GHz frequency band for dedicated fronthaul communications. Further the controller AP 102-a and the agent AP 102-b may continue to operate their respective radios B 511-a2 and 511-b2 on channel 36 within the 5 GHz frequency band for shared backhaul and fronthaul communications and may additionally continue to operate their respective radios C 511-a3 and 511-b3 on separate channels 1 and 11 with the 2.4 GHz frequency band for dedicated fronthaul communications.

For example, as shown in AP configuration 600-b, the controller AP 102-a may operate its radio A 611-a1 on channel 33 within the 6 GHz frequency band for dedicated fronthaul communications, while the agent AP 102-b may operate its radio A 611-b1 on channel 3 within the 6 GHz frequency band for dedicated fronthaul communications. Further the controller AP 102-a and the agent AP 102-b may continue to operate their respective radios B 611-a2 and 611-b2 on channel 149 within the 5G High frequency band for dedicated backhaul communications, may additionally continue to operate their respective radios C 611-a3 and 611-b3 on separate channels 36 and 48 with the 5G Low frequency band for dedicated fronthaul communications, and may additionally continue to operate their respective radios D 611-a4 and 611-b4 on separate channels 1 and 11 with the 2.4 GHz frequency band for dedicated fronthaul communications.

At 345, in some cases, after the controller AP 102-a reconfigures the backhaul to transition the backhaul from a MLO that utilizes a first quantity of backhaul links 206 to an SLO, or to an MLO that utilizes a second quantity of backhaul links 206 that is less than the first quantity of backhaul links 206, the agent AP 102-b may monitor one or more of the backhaul and fronthaul links 206 and may again send link information (at 305) to the controller AP 102-a. In some cases, based on the link information, the controller AP 102-a may determine that traffic associated with backhaul has increased such that now fewer backhaul links are no longer sufficient to support the backhaul traffic. Accordingly, the controller AP 102-a may perform a second reconfiguration (at 310) to transition the backhaul link back to MLO or back to a previous quantity of backhaul links 206. For instance, the controller AP 102-a may re-couple (e.g., add back) a backhaul link 206 previously decoupled from the controller AP 102-a and the agent AP 102-b (e.g., add back the first backhaul link 206-a). The controller AP 102-a may subsequently switch its radio A 511-a1 or 611-a1 (at 315), now recoupled to the first backhaul link 206-a, to a same channel that the agent AP 102-b operates its radio A 511-b1 or 611-b1 (now recoupled to the first backhaul link 206-a) on for fronthaul communications. The controller AP 102-a may send, to the agent AP 102-b, a second reconfiguration message (at 320) indicating the reconfiguration of the backhaul back to MLO or to an increased quantity of backhaul links 206. In some cases, the controller AP 102-a might not switch the channel of its radio A 511-a1 or 611-a1 and may, instead, identify a channel for the agent AP 102-b to switch to for shared backhaul and fronthaul communications (such as to again operating the radios A 511-a1 and 611-a1 as shared radios for communicating both backhaul and fronthaul communications), and may instruct the agent AP 102-b to switch to the different channel for shared backhaul and fronthaul communications. The agent AP 102-b may, as a result, switch its radio A 511-b1 or 611-b1 to the channel indicated by the second reconfiguration message (at 325). The controller AP 102-a and the agent AP 102-b may, thereafter, perform backhaul or fronthaul communications based on the reconfigured backhaul (at 330, 335, and 340). In some cases, based on the link conditions, the backhaul may operate in primary multi-link operation (P-MLO) mode or asynchronous multi-link multi-radio (AMLMR) mode.

Referring to FIG. 4, the signal flow 400 may reflect a flow of signals in the case where the wireless communication network (e.g., the wireless communication networks 100 or 200) operates as a decentralized network, in which the agent AP 102-b may control reconfiguration of backhaul to transition the backhaul from a MLO that utilizes a first quantity of backhaul links (e.g., N backhaul links) to an SLO, or to an MLO that utilizes a second quantity of backhaul links that is less than the first quantity of backhaul links (e.g., N-1 backhaul links).

At 405, an RM controller operating at the agent AP 102-b, such as the RM controller 207-b described with reference to FIG. 2, may monitor a condition of one or more of the backhaul and fronthaul links 206. For instance, the agent AP 102-b may monitor backhaul traffic (or expected backhaul traffic) associated with the first backhaul link 206-a or the second backhaul link 206-b. In some cases, the agent AP 102-b may monitor data traffic loads associated with one or more STAs that the agent AP 102-b communicates with via the fronthaul link B1 206-c, the fronthaul link B2 206-d, or the fronthaul link B3 206-e. In some cases, the agent AP 102-b may additionally, or alternatively, monitor OBSS associated with one or more of the backhaul or fronthaul links 206 or an amount of available airtime associated with one or more of the backhaul or fronthaul links 206.

At 410, based on the conditions of one or more of the backhaul and fronthaul links 206, the agent AP 102-b, such as the RM controller 207-b operating at the agent AP 102-b, may determine whether to reconfigure backhaul to transition from a MLO that utilizes a first quantity of backhaul links (e.g., N backhaul links) to an SLO, or to an MLO that utilizes a second quantity of backhaul links 206 that is less than the first quantity of backhaul links 206 (e.g., N-1 backhaul links). For instance, the agent AP 102-b may determine whether one or more of the link conditions satisfy a threshold (e.g., whether the backhaul traffic, the data traffic load, OBSS, an amount of available airtime, or a combination thereof, satisfies a corresponding threshold).

Based on whether the link conditions satisfy one or more of the thresholds, the agent AP 102-b may determine whether fewer backhaul links may be sufficient to support the backhaul traffic. If fewer backhaul links are determined to be sufficient to support the backhaul traffic, the agent AP 102-b may perform a reconfiguration of the backhaul to transition from a MLO that utilizes a first quantity of backhaul links (e.g., 2 backhaul links) to an SLO (e.g., 1 backhaul link), or to an MLO that utilizes a second quantity of backhaul links 206 that is less than the first quantity of backhaul links 206. Accordingly, reconfiguring the backhaul may involve the agent AP 102-b decoupling (e.g., terminating, deleting, etc.) one of backhaul links 206 that operates on a channel shared for fronthaul communications (e.g., the first backhaul links 206-a or the second backhaul links 206-b) from the controller AP 102-a and the agent AP 102-b. For instance, as shown in the AP configurations 500-b and 600-b of FIGS. 5 and 6, the agent AP 102-b may decouple the first backhaul link 206-a from the controller AP 102-a and the agent AP 102-b (the controller AP 102-a may decouple any one of the backhaul links and is not limited to decoupling the first backhaul link 206-a). In some cases, the controller AP 102-a may configure its backhaul traffic over a preferred backhaul link 206, and the agent AP 102-b may decouple a non-preferred backhaul link 206 in that case. By decoupling one of backhaul links 206 (e.g., the first backhaul link 206-a) that operated on a shared channel (e.g., channel 33 of the 6 GHz frequency band), using a shared radio (e.g., the radios A 511-a1 and 511-b1 for radios A 611-a1 and 611-b1), the previously-shared radio may be freed up for dedicated fronthaul communications. This may enable the controller AP 102-a and the agent AP 102-b to operate their respective previously-shared radios (e.g., the radios A 511-a1 and 511-b1 for radios A 611-a1 and 611-b1) on different (e.g., independent) channels for fronthaul communications, thereby increasing available airtime and reducing OBSS interference. This in turn may reduce latency at one or more associated STAs and may improve throughput at the network (e.g., the wireless communication networks 100 or 200).

At 415, the agent AP 102-b (e.g., the RM controller 207-b of the agent AP 102-b) may switch its previously-shared radio 511 or 611 to operate on a different channel for fronthaul communications. That is, the agent AP 102-a may switch its radio A 511-a1 or radio A 611-a1, which was previously coupled to the first backhaul link 206-a, to a different channel for dedicated fronthaul communication. By switching its radio A 511-b1 or 611-b1 to a different channel for fronthaul communications, the agent AP 102-b and the controller AP 102-a may operate on different channels (e.g., with the same frequency band) for independent fronthaul operation. This may enable a reduction in OBSS interference and increase in available airtime, thus, reducing latency at one or more associated STAs and may improve throughput at the network (e.g., the wireless communication networks 100 or 200).

At 420, the agent AP 102-b (e.g., the EM controller 209-b of the agent AP 102-b) may transmit a backhaul reconfiguration message to the controller AP 102-a. The backhaul reconfiguration message may include an indication of the reconfiguration of backhaul by the agent AP 102-b to transition the backhaul from a MLO that utilizes a first quantity of backhaul links to an SLO, or to an MLO that utilizes a second quantity of backhaul links 206 that is less than the first quantity of backhaul links 206. In some cases, the backhaul reconfiguration message may include an indication of the particular backhaul link 206 that was decoupled (e.g., terminated, deleted, etc.) from the controller AP 102-a and the agent AP 102-b. In some cases, the backhaul reconfiguration message may include an indication that the agent AP 102-b switched its radio A 511-b1 or radio A 611-b1, which was previously coupled to the first backhaul link 206-a, to operate on a different channel for dedicated fronthaul communication. In some cases, the backhaul reconfiguration message may include an indication of the new (e.g., different) channel that the agent AP 102-b operates its radio A 511-b1 or radio A 611-b1 on for the fronthaul communications. The EM controller 209-b operating at the agent AP 102-b may send an EM 1905 telemetry message including the backhaul reconfiguration message. The EM controller 209-b may send the EM 1905 telemetry message to the EM controller 209-a operating at the controller AP 102-a via one of the remaining the backhaul links 206, such as the second backhaul link 206-b. The EM controller 209-a may receive the backhaul reconfiguration message and send the message to the RM controller 207-a operating at the controller AP 102-a.

At 425, based on receiving the backhaul reconfiguration message, the controller AP 102-a (e.g., the RM controller 207-a operating at the controller AP 102-a) may perform an adjustment to its radio A 511-a1 or 611-a1. In some cases, performing the adjustment may involve the controller AP 102-a switching its radio A 511-a1 or radio A 611-a1, which was previously coupled to the first backhaul link 206-a, to operate on a different channel for dedicated fronthaul communication. In other cases, performing the adjustment may involve reducing a bandwidth associated with the radio A 511-a1 or 611-a1.

At 430, 435, and 440, based on the backhaul reconfiguration, the controller AP 102-a, the agent AP 102-b, or both may, thereafter, communicate fronthaul communications to one or more STAs, such as a first STA 104-a, by operating their respective radios A on different (e.g., independent) channels, and may communicate backhaul communications between one another on the remaining second backhaul link 206-b. For example, as shown in AP configuration 500-b, the controller AP 102-a may operate its radio A 511-a1 on channel 33 within the 6 GHz frequency band for dedicated fronthaul communications, while the agent AP 102-b may operate its radio A 511-b1 on channel 3 within the 6 GHz frequency band for dedicated fronthaul communications. Further the controller AP 102-a and the agent AP 102-b may continue to operate their respective radios B 511-a2 and 511-b2 on channel 36 within the 5 GHz frequency band for shared backhaul and fronthaul communications and may additionally continue to operate their respective radios C 511-a3 and 511-b3 on separate channels 1 and 11 with the 2.4 GHz frequency band for dedicated fronthaul communications.

For example, as shown in AP configuration 600-b, the controller AP 102-a may operate its radio A 611-a1 on channel 33 within the 6 GHz frequency band for dedicated fronthaul communications, while the agent AP 102-b may operate its radio A 611-b1 on channel 3 within the 6 GHz frequency band for dedicated fronthaul communications. Further the controller AP 102-a and the agent AP 102-b may continue to operate their respective radios B 611-a2 and 611-b2 on channel 149 within the 5G High frequency band for dedicated backhaul communications, may additionally continue to operate their respective radios C 611-a3 and 611-b3 on separate channels 36 and 48 with the 5G Low frequency band for dedicated fronthaul communications, and may additionally continue to operate their respective radios D 611-a4 and 611-b4 on separate channels 1 and 11 with the 2.4 GHz frequency band for dedicated fronthaul communications.

At 445, in some cases, after the agent AP 102-b reconfigures the backhaul to transition the backhaul from a MLO that utilizes a first quantity of backhaul links 206 to an SLO, or to an MLO that utilizes a second quantity of backhaul links 206 that is less than the first quantity of backhaul links 206, the agent AP 102-b may again monitor one or more conditions associated with the fronthaul and backhaul links 206 (at 405). In some cases, based on the link conditions, the agent AP 102-b may determine that traffic associated with backhaul has increased such that now fewer backhaul links are no longer sufficient to support the backhaul traffic. Accordingly, the agent AP 102-b may perform a second reconfiguration (at 410) to transition the backhaul link back to MLO or back to a previous quantity of backhaul links 206. For instance, the agent AP 102-b may re-couple (e.g., add back) a backhaul link 206 previously decoupled from the controller AP 102-a and the agent AP 102-b (e.g., add back the first backhaul link 206-a). The agent AP 102-b may subsequently switch its radio A 511-b1 or 611-b1 (at 415), now recoupled to the first backhaul link 206-a, to a same channel that the controller AP 102-a operates its radio A 511-a1 or 611-a1 (now recoupled to the first backhaul link 206-a) on for fronthaul communications. The agent AP 102-b may send, to the controller AP 102-a, a second reconfiguration message (at 420) indicating the reconfiguration of the backhaul back to MLO or to an increased quantity of backhaul links 206. The controller AP 102-a may, as a result, adjust its radio A 511-b1 or 611-b1 (at 425). For instance, the controller AP 102-a may switch its radio A 511-b1 or 611-b1 to a different channel or may adjust a bandwidth associated with the radio. The controller AP 102-a and the agent AP 102-b may, thereafter, perform backhaul or fronthaul communications based on the reconfigured backhaul (at 430, 435, and 440). In some cases, based on the link conditions, the backhaul may operate in P-MLO mode or AMLMR mode.

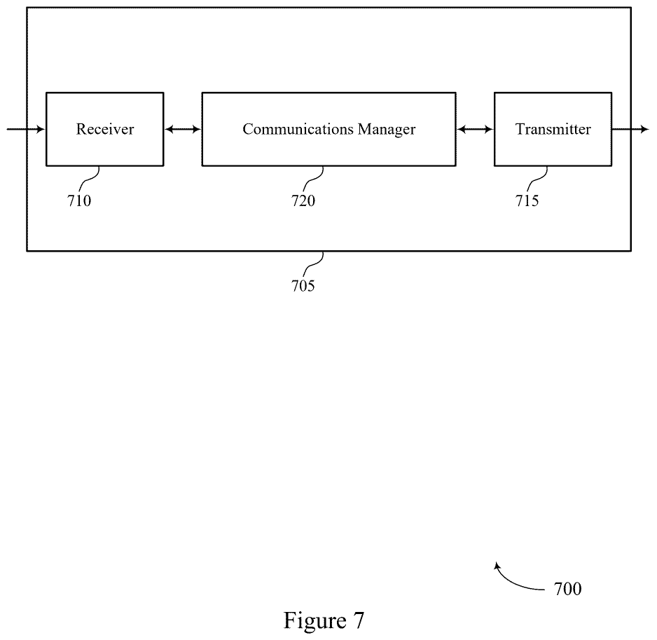

FIG. 7 shows a block diagram 700 of a device 705 that supports techniques for mesh independent channel fronthaul optimization in accordance with one or more aspects of the present disclosure. The device 705 may be an example of aspects of an AP as described herein. The device 705 may include a receiver 710, a transmitter 715, and a communications manager 720. The device 705, or one or more components of the device 705 (e.g., the receiver 710, the transmitter 715, the communications manager 720), may include at least one processor, which may be coupled with at least one memory, to, individually or collectively, support or enable the described techniques. Each of these components may be in communication with one another (e.g., via one or more buses).

The receiver 710 may provide a means for receiving information such as packets, user data, control information, or any combination thereof associated with various information channels (e.g., control channels, data channels, information channels related to techniques for mesh independent channel fronthaul optimization). Information may be passed on to other components of the device 705. The receiver 710 may utilize a single antenna or a set of multiple antennas.

The transmitter 715 may provide a means for transmitting signals generated by other components of the device 705. The transmitter 715 may utilize a single antenna or a set of multiple antennas.

The communications manager 720, the receiver 710, the transmitter 715, or various combinations or components thereof may be examples of means for performing various aspects of techniques for mesh independent channel fronthaul optimization as described herein. For example, the communications manager 720, the receiver 710, the transmitter 715, or various combinations or components thereof may be capable of performing one or more of the functions described herein.

In some examples, the communications manager 720, the receiver 710, the transmitter 715, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 720, the receiver 710, the transmitter 715, or various combinations or components thereof may be implemented in code (e.g., as communications management software or firmware) executed by at least one processor (e.g., referred to as a processor-executable code). If implemented in code executed by at least one processor, the functions of the communications manager 720, the receiver 710, the transmitter 715, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 720 may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communications in accordance with examples as disclosed herein. For example, the communications manager 720 is capable of, configured to, or operable to support a means for communicating with a second AP via: a first backhaul link using a first radio, of a set of multiple radios associated with the first AP, that operates on a first channel within a first frequency band, and a second backhaul link using a second radio, of the set of multiple radios, that operates on a second channel within a second frequency band. The communications manager 720 is capable of, configured to, or operable to support a means for communicating, with the second AP, a backhaul link reconfiguration message indicating a reconfiguration of a backhaul operation based on expected backhaul traffic between the first AP and the second AP, and based on an expected data traffic load of one or more STAs associated with the first AP, the second AP, or both, the backhaul link reconfiguration message indicating termination of the second backhaul link between the first AP and the second AP, and the backhaul link reconfiguration message indicating a switch by the first AP to operate the second radio on a third channel within the second frequency band for fronthaul communication. The communications manager 720 is capable of, configured to, or operable to support a means for transmitting, to the second AP and via the first backhaul link, a first backhaul message based on the backhaul link reconfiguration message.

Additionally, or alternatively, the communications manager 720 may support wireless communications in accordance with examples as disclosed herein. For example, the communications manager 720 is capable of, configured to, or operable to support a means for communicating with a first AP via: a first backhaul link using a first radio, of a set of multiple radios associated with the second AP, that operates on a first channel within a first frequency band, and a second backhaul link using a second radio, of the set of multiple radios, that operates on a second channel within a second frequency band. The communications manager 720 is capable of, configured to, or operable to support a means for communicating, with the first AP, a backhaul link reconfiguration message based on expected backhaul traffic between the first AP and the second AP, and based on an expected data traffic load of one or more STAs associated with the first AP, the second AP, or both, the backhaul link reconfiguration message including a first indication of a reconfiguration of a backhaul operation, a second indication of termination of the second backhaul link between the first AP and the second AP, and a third indication of a switch by the first AP to operate on a third channel within the second frequency band for fronthaul communication. The communications manager 720 is capable of, configured to, or operable to support a means for receiving, from the second AP and via the first backhaul link, a first backhaul message based on the backhaul link reconfiguration message.

By including or configuring the communications manager 720 in accordance with examples as described herein, the device 705 (e.g., at least one processor controlling or otherwise coupled with the receiver 710, the transmitter 715, the communications manager 720, or a combination thereof) may support techniques for more efficient utilization of communication resources.

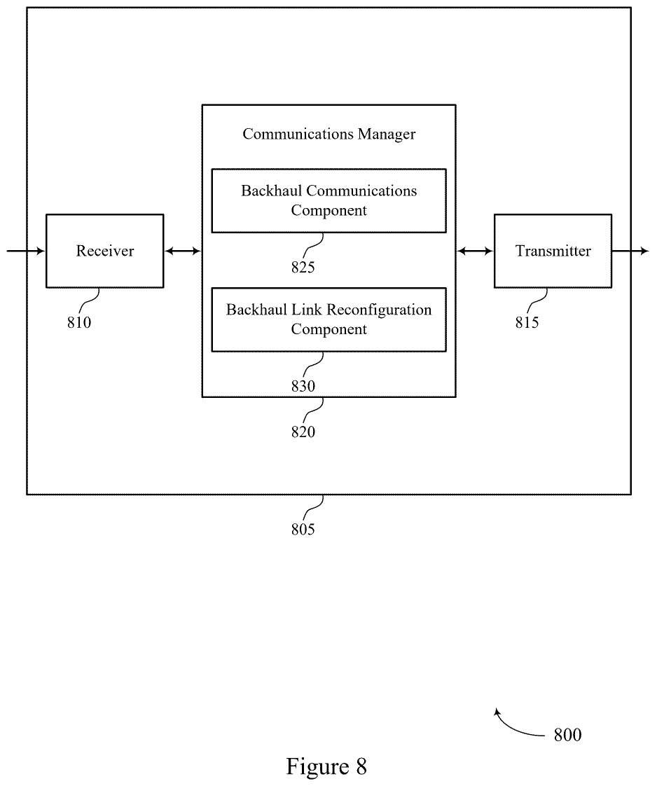

FIG. 8 shows a block diagram 800 of a device 805 that supports techniques for mesh independent channel fronthaul optimization in accordance with one or more aspects of the present disclosure. The device 805 may be an example of aspects of a device 705 or an AP 102 as described herein. The device 805 may include a receiver 810, a transmitter 815, and a communications manager 820. The device 805, or one of more components of the device 805 (e.g., the receiver 810, the transmitter 815, the communications manager 820), may include at least one processor, which may be coupled with at least one memory, to support the described techniques. Each of these components may be in communication with one another (e.g., via one or more buses).

The receiver 810 may provide a means for receiving information such as packets, user data, control information, or any combination thereof associated with various information channels (e.g., control channels, data channels, information channels related to techniques for mesh independent channel fronthaul optimization). Information may be passed on to other components of the device 805. The receiver 810 may utilize a single antenna or a set of multiple antennas.

The transmitter 815 may provide a means for transmitting signals generated by other components of the device 805. The transmitter 815 may utilize a single antenna or a set of multiple antennas.

The device 805, or various components thereof, may be an example of means for performing various aspects of techniques for mesh independent channel fronthaul optimization as described herein. For example, the communications manager 820 may include a backhaul communications component 825 a backhaul link reconfiguration component 830, or any combination thereof. The communications manager 820 may be an example of aspects of a communications manager 720 as described herein. In some examples, the communications manager 820, or various components thereof, may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communications in accordance with examples as disclosed herein. The backhaul communications component 825 is capable of, configured to, or operable to support a means for communicating with a second AP via: a first backhaul link using a first radio, of a set of multiple radios associated with the first AP, that operates on a first channel within a first frequency band, and a second backhaul link using a second radio, of the set of multiple radios, that operates on a second channel within a second frequency band. The backhaul link reconfiguration component 830 is capable of, configured to, or operable to support a means for communicating, with the second AP, a backhaul link reconfiguration message indicating a reconfiguration of a backhaul operation based on expected backhaul traffic between the first AP and the second AP, and based on an expected data traffic load of one or more STAs associated with the first AP, the second AP, or both, the backhaul link reconfiguration message indicating termination of the second backhaul link between the first AP and the second AP, and the backhaul link reconfiguration message indicating a switch by the first AP to operate the second radio on a third channel within the second frequency band for fronthaul communication. The backhaul communications component 825 is capable of, configured to, or operable to support a means for transmitting, to the second AP and via the first backhaul link, a first backhaul message based on the backhaul link reconfiguration message.

Additionally, or alternatively, the communications manager 820 may support wireless communications in accordance with examples as disclosed herein. The backhaul communications component 825 is capable of, configured to, or operable to support a means for communicating with a first AP via: a first backhaul link using a first radio, of a set of multiple radios associated with the second AP, that operates on a first channel within a first frequency band, and a second backhaul link using a second radio, of the set of multiple radios, that operates on a second channel within a second frequency band. The backhaul link reconfiguration component 830 is capable of, configured to, or operable to support a means for communicating, with the first AP, a backhaul link reconfiguration message based on expected backhaul traffic between the first AP and the second AP, and based on an expected data traffic load of one or more STAs associated with the first AP, the second AP, or both, the backhaul link reconfiguration message including a first indication of a reconfiguration of a backhaul operation, a second indication of termination of the second backhaul link between the first AP and the second AP, and a third indication of a switch by the first AP to operate on a third channel within the second frequency band for fronthaul communication. The backhaul communications component 825 is capable of, configured to, or operable to support a means for receiving, from the second AP and via the first backhaul link, a first backhaul message based on the backhaul link reconfiguration message.

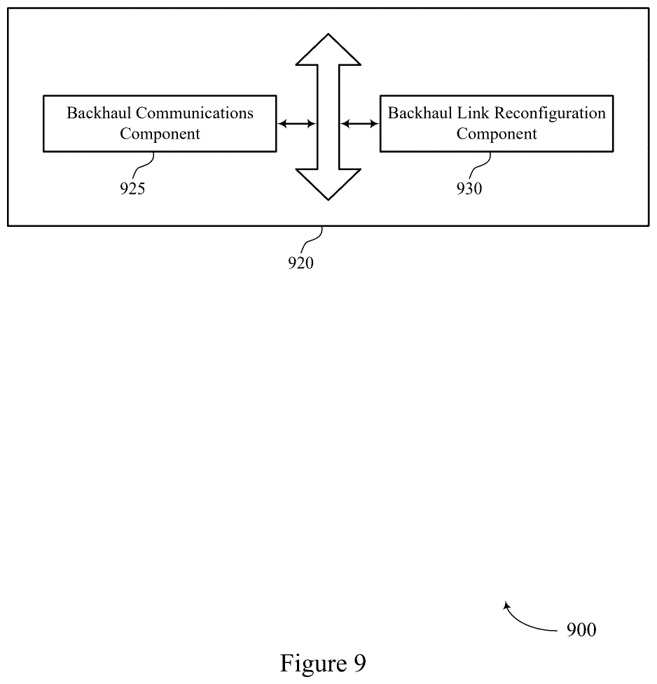

FIG. 9 shows a block diagram 900 of a communications manager 920 that supports techniques for mesh independent channel fronthaul optimization in accordance with one or more aspects of the present disclosure. The communications manager 920 may be an example of aspects of a communications manager 720, a communications manager 820, or both, as described herein. The communications manager 920, or various components thereof, may be an example of means for performing various aspects of techniques for mesh independent channel fronthaul optimization as described herein. For example, the communications manager 920 may include a backhaul communications component 925 a backhaul link reconfiguration component 930, or any combination thereof. Each of these components, or components or subcomponents thereof (e.g., one or more processors, one or more memories), may communicate, directly or indirectly, with one another (e.g., via one or more buses).

The communications manager 920 may support wireless communications in accordance with examples as disclosed herein. The backhaul communications component 925 is capable of, configured to, or operable to support a means for communicating with a second AP via: a first backhaul link using a first radio, of a set of multiple radios associated with the first AP, that operates on a first channel within a first frequency band, and a second backhaul link using a second radio, of the set of multiple radios, that operates on a second channel within a second frequency band. The backhaul link reconfiguration component 930 is capable of, configured to, or operable to support a means for communicating, with the second AP, a backhaul link reconfiguration message indicating a reconfiguration of a backhaul operation based on expected backhaul traffic between the first AP and the second AP, and based on an expected data traffic load of one or more STAs associated with the first AP, the second AP, or both, the backhaul link reconfiguration message indicating termination of the second backhaul link between the first AP and the second AP, and the backhaul link reconfiguration message indicating a switch by the first AP to operate the second radio on a third channel within the second frequency band for fronthaul communication. In some examples, the backhaul communications component 925 is capable of, configured to, or operable to support a means for transmitting, to the second AP and via the first backhaul link, a first backhaul message based on the backhaul link reconfiguration message.

In some examples, the backhaul link reconfiguration component 930 is capable of, configured to, or operable to support a means for receiving, from the second AP, a second backhaul message including link information, where the backhaul link reconfiguration message is communicated based on the link information.

In some examples, the backhaul link reconfiguration message further includes an indication a fourth channel within the second frequency band to use for fronthaul communication. In some examples, the fourth channel is different from the third channel.

In some examples, termination of the second backhaul link between the first AP and the second AP is based at least in part on one or more of: OBSS interference associated with one or more links associated with the first AP satisfying an interference threshold, a channel condition associated with one or more links associated with the first AP satisfying a channel condition threshold, available airtime associated with one or more links associated with the first AP satisfying an available airtime threshold, or any combination thereof.

In some examples, the backhaul link reconfiguration component 930 is capable of, configured to, or operable to support a means for communicating, to the second AP, a second backhaul link reconfiguration message based on a channel condition associated with the first backhaul link satisfying a channel condition threshold, where the second backhaul link reconfiguration message indicates a second switch by the first AP to operate the second radio on the second channel within the second frequency band for backhaul communication.

In some examples, the second backhaul link operates in P-MLO mode or AMLMR mode.

In some examples, after the switch to operate the second radio on the third channel within the second frequency band, the first AP and the second AP operate on independent channels, within the second frequency band, for fronthaul communication.

In some examples, the first radio used for the first backhaul link is also used for a first fronthaul link. In some examples, prior to the reconfiguration of the backhaul operation, the second radio used for the second backhaul link is also used for a second fronthaul link. In some examples, after the reconfiguration of the backhaul operation, the second radio is dedicated for fronthaul communication.

In some examples, the first AP further communicates with the second AP via a third radio, of the set of multiple radios, that operates on a fifth channel within a third frequency band, where the fifth channel within the third frequency band is used for a first fronthaul link, a fourth radio, of the set of multiple radios, that operates on a sixth channel within a fourth frequency band, where the sixth channel within the fourth frequency band is used for a second fronthaul link, or a combination thereof.

In some examples, the first radio used for the first backhaul link is dedicated for backhaul communication, and the third radio used for the first fronthaul link and the fourth radio used for the second fronthaul link are dedicated for fronthaul communication. In some examples, prior to the reconfiguration of the backhaul operation, the second radio used for the second backhaul link is also used for a third fronthaul link. In some examples, after the reconfiguration of the single link backhaul operation, the second radio is dedicated for fronthaul communication.

In some examples, the first AP is a controller AP and the second AP is an agent AP. In some examples, the first AP is an agent AP and the second AP is a controller AP.

In some examples, the reconfiguration of the backhaul operation includes a transition of the backhaul operation from a first quantity of backhaul links to a second quantity of backhaul links. In some examples, the second quantity of backhaul links is less than the first quantity of backhaul links.

In some examples, the first quantity of backhaul links is equal to a maximum quantity of MLO links for a backhaul network associated with the first AP.

Additionally, or alternatively, the communications manager 920 may support wireless communications in accordance with examples as disclosed herein. In some examples, the backhaul communications component 925 is capable of, configured to, or operable to support a means for communicating with a first AP via: a first backhaul link using a first radio, of a set of multiple radios associated with the second AP, that operates on a first channel within a first frequency band, and a second backhaul link using a second radio, of the set of multiple radios, that operates on a second channel within a second frequency band. In some examples, the backhaul link reconfiguration component 930 is capable of, configured to, or operable to support a means for communicating, with the first AP, a backhaul link reconfiguration message based on expected backhaul traffic between the first AP and the second AP, and based on an expected data traffic load of one or more STAs associated with the first AP, the second AP, or both, the backhaul link reconfiguration message including a first indication of a reconfiguration of a backhaul operation, a second indication of termination of the second backhaul link between the first AP and the second AP, and a third indication of a switch by the first AP to operate on a third channel within the second frequency band for fronthaul communication. In some examples, the backhaul communications component 925 is capable of, configured to, or operable to support a means for receiving, from the second AP and via the first backhaul link, a first backhaul message based on the backhaul link reconfiguration message.

In some examples, the backhaul link reconfiguration component 930 is capable of, configured to, or operable to support a means for transmitting, to the first AP, a second backhaul message including link information, where the backhaul link reconfiguration message is communicated based on the link information.

In some examples, the backhaul link reconfiguration component 930 is capable of, configured to, or operable to support a means for receiving, from the first AP and based on a channel condition associated with the first backhaul link satisfying a channel condition threshold, a second backhaul link reconfiguration message indicating a second switch by the first AP to operate on the second channel within the second frequency band for backhaul communication.

In some examples, after the switch by the first AP to operate on the second channel within the second frequency band for fronthaul communication, the first AP and the second AP operate on independent channels, within the second frequency band, for fronthaul communication.

In some examples, the second AP further communicates with the second AP via a third radio, of the set of multiple radios, that operates on a fifth channel within a third frequency band, where the fifth channel within the third frequency band is used for a first fronthaul link, a fourth radio, of the set of multiple radios, that operates on a sixth channel within a fourth frequency band, where the sixth channel within the fourth frequency band is used for a second fronthaul link, or a combination thereof.

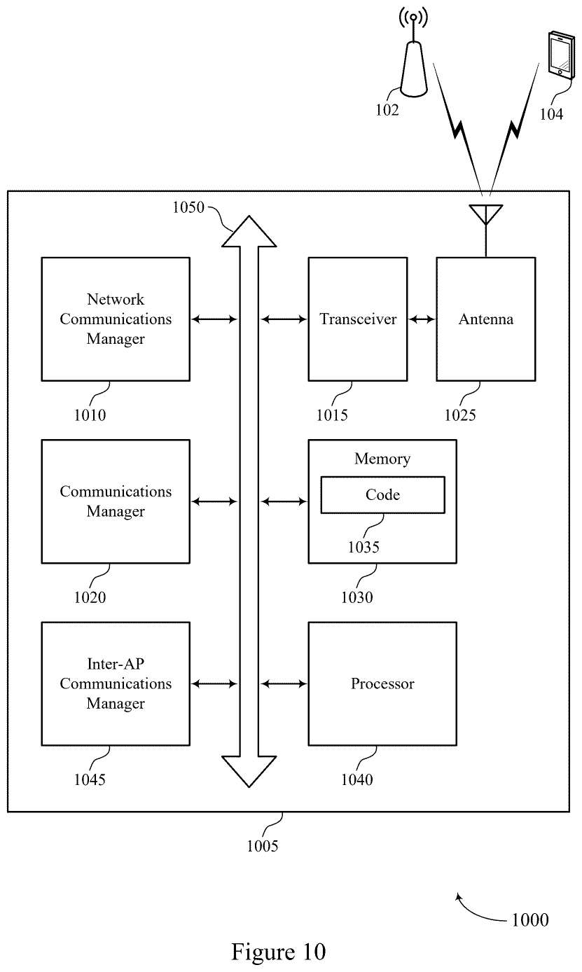

FIG. 10 shows a diagram of a system 1000 including a device 1005 that supports techniques for mesh independent channel fronthaul optimization in accordance with one or more aspects of the present disclosure. The device 1005 may be an example of or include components of a device 705, a device 805, or an AP as described herein. The device 1005 may include components for bi-directional voice and data communications including components for transmitting and receiving communications, such as a communications manager 1020, a network communications manager 1010, a transceiver 1015, one or more antennas 1025, at least one memory 1030, code 1035, at least one processor 1040, and an inter-AP communications manager 1045. These components may be in electronic communication or otherwise coupled (e.g., operatively, communicatively, functionally, electronically, electrically) via one or more buses (e.g., a bus 1050).

The network communications manager 1010 may manage communications with a core network (e.g., via one or more wired backhaul links). For example, the network communications manager 1010 may manage the transfer of data communications for client devices, such as one or more STAs 104.

In some cases, the device 1005 may include a single antenna. However, in some other cases the device 1005 may have more than one antenna, which may be capable of concurrently transmitting or receiving multiple wireless transmissions. The transceiver 1015 may communicate bi-directionally via the one or more antennas 1025 using wired or wireless links as described herein. For example, the transceiver 1015 may represent a wireless transceiver and may communicate bi-directionally with another wireless transceiver. The transceiver 1015 may also include a modem to modulate the packets and provide the modulated packets to one or more antennas 1025 for transmission, and to demodulate packets received from the one or more antennas 1025. The transceiver 1015, or the transceiver 1015 and one or more antennas 1025, may be an example of a transmitter 715, a transmitter 815, a receiver 710, a receiver 810, or any combination thereof or component thereof, as described herein.

The memory 1030 may include RAM and ROM. The memory 1030 may store computer-readable, computer-executable, or processor-executable code, such as code 1035. The code 1035 may include instructions that, when executed by the processor 1040, cause the device 1005 to perform various functions described herein. In some cases, the memory 1030 may include, among other things, a BIOS which may control basic hardware or software operation such as the interaction with peripheral components or devices.

The processor 1040 may include an intelligent hardware device, (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1040 may be configured to operate a memory array using a memory controller. In some other cases, a memory controller may be integrated into the processor 1040. The processor 1040 may be configured to execute computer-readable instructions stored in a memory (e.g., the memory 1030) to cause the device 1005 to perform various functions (e.g., functions or tasks supporting techniques for mesh independent channel fronthaul optimization). For example, the device 1005 or a component of the device 1005 may include a processor 1040 and memory 1030 coupled to the processor 1040, the processor 1040 and memory 1030 configured to perform various functions described herein.

The inter-AP communications manager 1045 may manage communications with other APs 102, and may include a controller or scheduler for controlling communications with STAs 104 in cooperation with other APs 102. For example, the inter-AP communications manager 1045 may coordinate scheduling for transmissions to APs 102 for various interference mitigation techniques such as beamforming or joint transmission. In some examples, the inter-AP communications manager 1045 may provide an X2 interface within an LTE/LTE-A wireless communication network technology to provide communication between APs 102.

The communications manager 1020 may support wireless communications in accordance with examples as disclosed herein. For example, the communications manager 1020 is capable of, configured to, or operable to support a means for communicating with a second AP via: a first backhaul link using a first radio, of a set of multiple radios associated with the first AP, that operates on a first channel within a first frequency band, and a second backhaul link using a second radio, of the set of multiple radios, that operates on a second channel within a second frequency band. The communications manager 1020 is capable of, configured to, or operable to support a means for communicating, with the second AP, a backhaul link reconfiguration message indicating a reconfiguration of a backhaul operation based on expected backhaul traffic between the first AP and the second AP, and based on an expected data traffic load of one or more STAs associated with the first AP, the second AP, or both, the backhaul link reconfiguration message indicating termination of the second backhaul link between the first AP and the second AP, and the backhaul link reconfiguration message indicating a switch by the first AP to operate the second radio on a third channel within the second frequency band for fronthaul communication. The communications manager 1020 is capable of, configured to, or operable to support a means for transmitting, to the second AP and via the first backhaul link, a first backhaul message based on the backhaul link reconfiguration message.

Additionally, or alternatively, the communications manager 1020 may support wireless communications in accordance with examples as disclosed herein. For example, the communications manager 1020 is capable of, configured to, or operable to support a means for communicating with a first AP via: a first backhaul link using a first radio, of a set of multiple radios associated with the second AP, that operates on a first channel within a first frequency band, and a second backhaul link using a second radio, of the set of multiple radios, that operates on a second channel within a second frequency band. The communications manager 1020 is capable of, configured to, or operable to support a means for communicating, with the first AP, a backhaul link reconfiguration message based on expected backhaul traffic between the first AP and the second AP, and based on an expected data traffic load of one or more STAs associated with the first AP, the second AP, or both, the backhaul link reconfiguration message including a first indication of a reconfiguration of a backhaul operation, a second indication of termination of the second backhaul link between the first AP and the second AP, and a third indication of a switch by the first AP to operate on a third channel within the second frequency band for fronthaul communication. The communications manager 1020 is capable of, configured to, or operable to support a means for receiving, from the second AP and via the first backhaul link, a first backhaul message based on the backhaul link reconfiguration message.

By including or configuring the communications manager 1020 in accordance with examples as described herein, the device 1005 may support techniques for improved communication reliability, reduced latency, and more efficient utilization of communication resources.

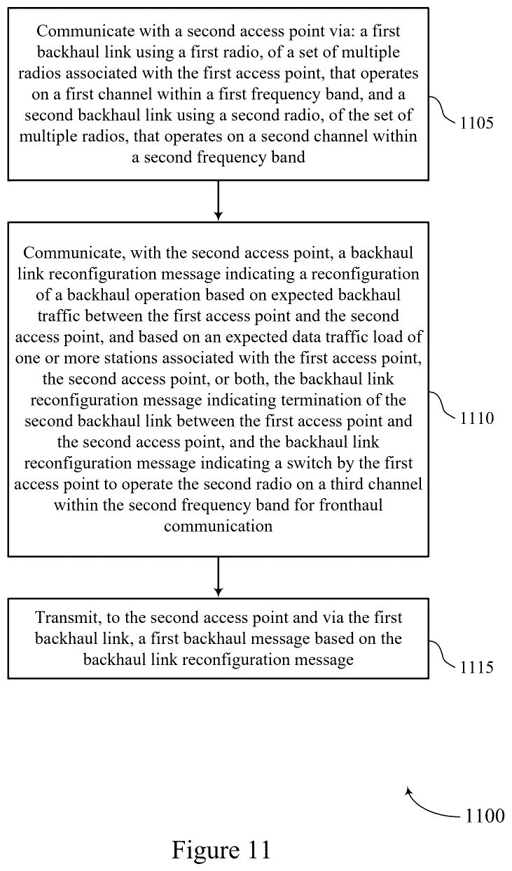

FIG. 11 shows a flowchart illustrating a method 1100 that supports techniques for mesh independent channel fronthaul optimization in accordance with one or more aspects of the present disclosure. The operations of the method 1100 may be implemented by an AP or its components as described herein. For example, the operations of the method 1100 may be performed by an AP as described with reference to FIGS. 1 through 10. In some examples, an AP may execute a set of instructions to control the functional elements of the wireless AP to perform the described functions. Additionally, or alternatively, the wireless AP may perform aspects of the described functions using special-purpose hardware.

At 1105, the method may include communicating with a second AP via: a first backhaul link using a first radio, of a set of multiple radios associated with the first AP, that operates on a first channel within a first frequency band, and a second backhaul link using a second radio, of the set of multiple radios, that operates on a second channel within a second frequency band. The operations of 1105 may be performed in accordance with examples as disclosed herein. In some examples, aspects of the operations of 1105 may be performed by a backhaul communications component 925 as described with reference to FIG. 9.

At 1110, the method may include communicating, with the second AP, a backhaul link reconfiguration message indicating a reconfiguration of a backhaul operation based on expected backhaul traffic between the first AP and the second AP, and based on an expected data traffic load of one or more STAs associated with the first AP, the second AP, or both, the backhaul link reconfiguration message indicating termination of the second backhaul link between the first AP and the second AP, and the backhaul link reconfiguration message indicating a switch by the first AP to operate the second radio on a third channel within the second frequency band for fronthaul communication. The operations of 1110 may be performed in accordance with examples as disclosed herein. In some examples, aspects of the operations of 1110 may be performed by a backhaul link reconfiguration component 930 as described with reference to FIG. 9.

At 1115, the method may include transmitting, to the second AP and via the first backhaul link, a first backhaul message based on the backhaul link reconfiguration message. The operations of 1115 may be performed in accordance with examples as disclosed herein. In some examples, aspects of the operations of 1115 may be performed by a backhaul communications component 925 as described with reference to FIG. 9.

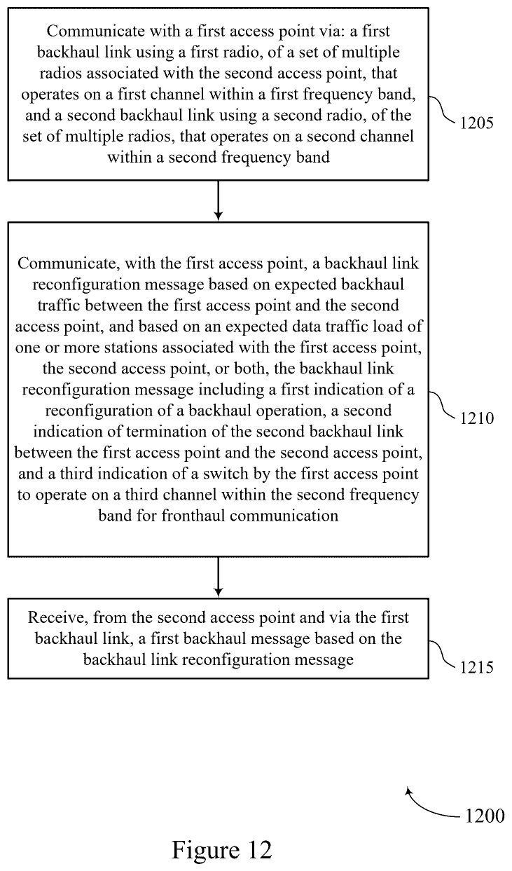

FIG. 12 shows a flowchart illustrating a method 1200 that supports techniques for mesh independent channel fronthaul optimization in accordance with one or more aspects of the present disclosure. The operations of the method 1200 may be implemented by an AP or its components as described herein. For example, the operations of the method 1200 may be performed by an AP as described with reference to FIGS. 1 through 10. In some examples, an AP may execute a set of instructions to control the functional elements of the wireless AP to perform the described functions. Additionally, or alternatively, the wireless AP may perform aspects of the described functions using special-purpose hardware.

At 1205, the method may include communicating with a first AP via: a first backhaul link using a first radio, of a set of multiple radios associated with the second AP, that operates on a first channel within a first frequency band, and a second backhaul link using a second radio, of the set of multiple radios, that operates on a second channel within a second frequency band. The operations of 1205 may be performed in accordance with examples as disclosed herein. In some examples, aspects of the operations of 1205 may be performed by a backhaul communications component 925 as described with reference to FIG. 9.

At 1210, the method may include communicating, with the first AP, a backhaul link reconfiguration message based on expected backhaul traffic between the first AP and the second AP, and based on an expected data traffic load of one or more STAs associated with the first AP, the second AP, or both, the backhaul link reconfiguration message including a first indication of a reconfiguration of a backhaul operation, a second indication of termination of the second backhaul link between the first AP and the second AP, and a third indication of a switch by the first AP to operate on a third channel within the second frequency band for fronthaul communication. The operations of 1210 may be performed in accordance with examples as disclosed herein. In some examples, aspects of the operations of 1210 may be performed by a backhaul link reconfiguration component 930 as described with reference to FIG. 9.

At 1215, the method may include receiving, from the second AP and via the first backhaul link, a first backhaul message based on the backhaul link reconfiguration message. The operations of 1215 may be performed in accordance with examples as disclosed herein. In some examples, aspects of the operations of 1215 may be performed by a backhaul communications component 925 as described with reference to FIG. 9.

The following provides an overview of aspects of the present disclosure:

Aspect 1: A method for wireless communications by a first access point, comprising: communicating with a second access point via: a first backhaul link using a first radio, of a plurality of radios associated with the first access point, that operates on a first channel within a first frequency band, and a second backhaul link using a second radio, of the plurality of radios, that operates on a second channel within a second frequency band; communicating, with the second access point, a backhaul link reconfiguration message indicating a reconfiguration of a backhaul operation based at least in part on expected backhaul traffic between the first access point and the second access point, and based at least in part on an expected data traffic load of one or more stations associated with the first access point, the second access point, or both, the backhaul link reconfiguration message indicating termination of the second backhaul link between the first access point and the second access point, and the backhaul link reconfiguration message indicating a switch by the first access point to operate the second radio on a third channel within the second frequency band for fronthaul communication; and transmitting, to the second access point and via the first backhaul link, a first backhaul message based at least in part on the backhaul link reconfiguration message.

Aspect 2: The method of aspect 1, further comprising: receiving, from the second access point, a second backhaul message including link information, wherein the backhaul link reconfiguration message is communicated based at least in part on the link information.

Aspect 3: The method of any of aspects 1 through 2, wherein the backhaul link reconfiguration message further includes an indication a fourth channel within the second frequency band to use for fronthaul communication, the fourth channel is different from the third channel.

Aspect 4: The method of any of aspects 1 through 3, wherein termination of the second backhaul link between the first access point and the second access point is based at least in part on one or more of overlapping basic service set (OBSS) interference associated with one or more links associated with the first access point satisfying an interference threshold, a channel condition associated with one or more links associated with the first access point satisfying a channel condition threshold, available airtime associated with one or more links associated with the first access point satisfying an available airtime threshold, or any combination thereof.

Aspect 5: The method of any of aspects 1 through 4, further comprising: communicating, to the second access point, a second backhaul link reconfiguration message based at least in part on a channel condition associated with the first backhaul link satisfying a channel condition threshold, wherein the second backhaul link reconfiguration message indicates a second switch by the first access point to operate the second radio on the second channel within the second frequency band for backhaul communication.

Aspect 6: The method of any of aspects 1 through 5, wherein the second backhaul link operates in primary multi-link operation (P-MLO) mode or asynchronous multi-link multi-radio (AMLMR) mode.

Aspect 7: The method of any of aspects 1 through 6, wherein after the switch to operate the second radio on the third channel within the second frequency band, the first access point and the second access point operate on independent channels, within the second frequency band, for fronthaul communication.

Aspect 8: The method of any of aspects 1 through 7, wherein the first radio used for the first backhaul link is also used for a first fronthaul link, prior to the reconfiguration of the backhaul operation, the second radio used for the second backhaul link is also used for a second fronthaul link, and after the reconfiguration of the backhaul operation, the second radio is dedicated for fronthaul communication.

Aspect 9: The method of any of aspects 1 through 8, wherein the first access point further communicates with the second access point via a third radio, of the plurality of radios, that operates on a fifth channel within a third frequency band, wherein the fifth channel within the third frequency band is used for a first fronthaul link, a fourth radio, of the plurality of radios, that operates on a sixth channel within a fourth frequency band, wherein the sixth channel within the fourth frequency band is used for a second fronthaul link, or a combination thereof.

Aspect 10: The method of aspect 9, wherein the first radio used for the first backhaul link is dedicated for backhaul communication, and the third radio used for the first fronthaul link and the fourth radio used for the second fronthaul link are dedicated for fronthaul communication, prior to the reconfiguration of the backhaul operation, the second radio used for the second backhaul link is also used for a third fronthaul link, and after the reconfiguration of the single link backhaul operation, the second radio is dedicated for fronthaul communication.

Aspect 11: The method of any of aspects 1 through 10, wherein the first access point is a controller access point and the second access point is an agent access point, or the first access point is an agent access point and the second access point is a controller access point.

Aspect 12: The method of any of aspects 1 through 11, wherein the reconfiguration of the backhaul operation comprises a transition of the backhaul operation from a first quantity of backhaul links to a second quantity of backhaul links, the second quantity of backhaul links is less than the first quantity of backhaul links.

Aspect 13: The method of any of aspects 1 through 12, wherein the first quantity of backhaul links is equal to a maximum quantity of multi-link operation (MLO) links for a backhaul network associated with the first access point.

Aspect 14: A method for wireless communications by a second access point, comprising: communicating with a first access point via: a first backhaul link using a first radio, of a plurality of radios associated with the second access point, that operates on a first channel within a first frequency band, and a second backhaul link using a second radio, of the plurality of radios, that operates on a second channel within a second frequency band; communicating, with the first access point, a backhaul link reconfiguration message based at least in part on expected backhaul traffic between the first access point and the second access point, and based at least in part on an expected data traffic load of one or more stations associated with the first access point, the second access point, or both, the backhaul link reconfiguration message including a first indication of a reconfiguration of a backhaul operation, a second indication of termination of the second backhaul link between the first access point and the second access point, and a third indication of a switch by the first access point to operate on a third channel within the second frequency band for fronthaul communication; and receiving, from the second access point and via the first backhaul link, a first backhaul message based at least in part on the backhaul link reconfiguration message.

Aspect 15: The method of aspect 14, further comprising: transmitting, to the first access point, a second backhaul message including link information, wherein the backhaul link reconfiguration message is communicated based at least in part on the link information.

Aspect 16: The method of any of aspects 14 through 15, wherein the backhaul link reconfiguration message further includes an indication a fourth channel within the second frequency band to use for fronthaul communication, the fourth channel is different from the third channel.

Aspect 17: The method of any of aspects 14 through 16, wherein termination of the second backhaul link between the first access point and the second access point is based at least in part on one or more of overlapping basic service set (OBSS) interference associated with one or more links associated with the first access point satisfying an interference threshold, a channel condition associated with one or more links associated with the first access point satisfying a channel condition threshold, available airtime associated with one or more links associated with the first access point satisfying an available airtime threshold, or any combination thereof.

Aspect 18: The method of any of aspects 14 through 17, further comprising: receiving, from the first access point and based at least in part on a channel condition associated with the first backhaul link satisfying a channel condition threshold, a second backhaul link reconfiguration message indicating a second switch by the first access point to operate on the second channel within the second frequency band for backhaul communication.

Aspect 19: The method of any of aspects 14 through 18, wherein the second backhaul link operates in primary multi-link operation (P-MLO) mode or asynchronous multi-link multi-radio (AMLMR) mode.

Aspect 20: The method of any of aspects 14 through 19, wherein after the switch by the first access point to operate on the second channel within the second frequency band for fronthaul communication, the first access point and the second access point operate on independent channels, within the second frequency band, for fronthaul communication.

Aspect 21: The method of any of aspects 14 through 20, wherein the first radio used for the first backhaul link is also used for a first fronthaul link, prior to the reconfiguration of the backhaul operation, the second radio used for the second backhaul link is also used for a second fronthaul link, and after the reconfiguration of the backhaul operation, the second radio is dedicated for fronthaul communication.

Aspect 22: The method of any of aspects 14 through 21, wherein the second access point further communicates with the first access point via a third radio, of the plurality of radios, that operates on a fifth channel within a third frequency band, wherein the fifth channel within the third frequency band is used for a first fronthaul link, a fourth radio, of the plurality of radios, that operates on a sixth channel within a fourth frequency band, wherein the sixth channel within the fourth frequency band is used for a second fronthaul link, or a combination thereof.

Aspect 23: The method of aspect 22, wherein the first radio used for the first backhaul link is dedicated for backhaul communication, and the third radio used for the first fronthaul link and the fourth radio used for the second fronthaul link are dedicated for fronthaul communication, prior to the reconfiguration of the backhaul operation, the second radio used for the second backhaul link is also used for a third fronthaul link, and after the reconfiguration of the backhaul operation, the second radio is dedicated for fronthaul communication.

Aspect 24: The method of any of aspects 14 through 23, wherein the first access point is a controller access point and the second access point is an agent access point or the first access point is an agent access point and the second access point is a controller access point.

Aspect 25: The method of any of aspects 14 through 24, wherein the reconfiguration of the backhaul operation comprises a transition of the backhaul operation from a first quantity of backhaul links to a second quantity of backhaul links, the second quantity of backhaul links is less than the first quantity of backhaul links.

Aspect 26: The method of any of aspects 14 through 25, wherein the first quantity of backhaul links is equal to a maximum quantity of multi-link operation (MLO) links for a backhaul network associated with the second access point.

Aspect 27: A first access point for wireless communications, comprising one or more memories storing processor-executable code, and one or more processors coupled with the one or more memories and individually or collectively operable to execute the code to cause the first access point to perform a method of any of aspects 1 through 13.

Aspect 28: A first access point for wireless communications, comprising at least one means for performing a method of any of aspects 1 through 13.

Aspect 29: A non-transitory computer-readable medium storing code for wireless communications, the code comprising instructions executable by one or more processors to perform a method of any of aspects 1 through 13.

Aspect 30: A second access point for wireless communications, comprising one or more memories storing processor-executable code, and one or more processors coupled with the one or more memories and individually or collectively operable to execute the code to cause the second access point to perform a method of any of aspects 14 through 26.

Aspect 31: A second access point for wireless communications, comprising at least one means for performing a method of any of aspects 14 through 26.

Aspect 32: A non-transitory computer-readable medium storing code for wireless communications, the code comprising instructions executable by one or more processors to perform a method of any of aspects 14 through 26.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A first access point, comprising:
one or more memories storing processor-executable code; and
one or more processors coupled with the one or more memories and individually or collectively operable to execute the code to cause the first access point to:
communicate with a second access point via: a first backhaul link using a first radio, of a plurality of radios associated with the first access point, that operates on a first channel within a first frequency band, and a second backhaul link using a second radio, of the plurality of radios, that operates on a second channel within a second frequency band;
communicate, with the second access point, a backhaul link reconfiguration message indicating a reconfiguration of a backhaul operation based at least in part on expected backhaul traffic between the first access point and the second access point, and based at least in part on an expected data traffic load of one or more stations associated with the first access point, the second access point, or both,
the backhaul link reconfiguration message indicating termination of the second backhaul link between the first access point and the second access point, and
the backhaul link reconfiguration message indicating a switch by the first access point to operate the second radio on a third channel within the second frequency band for fronthaul communication; and
transmit, to the second access point and via the first backhaul link, a first backhaul message based at least in part on the backhaul link reconfiguration message.

2. The first access point of claim 1, wherein the one or more processors are individually or collectively further operable to execute the code to cause the first access point to:
receive, from the second access point, a second backhaul message including link information, wherein the backhaul link reconfiguration message is communicated based at least in part on the link information.

3. The first access point of claim 1, wherein:
the backhaul link reconfiguration message further includes an indication a fourth channel within the second frequency band to use for fronthaul communication, and
the fourth channel is different from the third channel.

4. The first access point of claim 1, wherein termination of the second backhaul link between the first access point and the second access point is based at least in part on one or more of: overlapping basic service set (OBSS) interference associated with one or more links associated with the first access point satisfying an interference threshold, a channel condition associated with one or more links associated with the first access point satisfying a channel condition threshold, available airtime associated with one or more links associated with the first access point satisfying an available airtime threshold, or any combination thereof.

5. The first access point of claim 1, wherein the one or more processors are individually or collectively further operable to execute the code to cause the first access point to:
communicate, to the second access point, a second backhaul link reconfiguration message based at least in part on a channel condition associated with the first backhaul link satisfying a channel condition threshold, wherein the second backhaul link reconfiguration message indicates a second switch by the first access point to operate the second radio on the second channel within the second frequency band for backhaul communication.

6. The first access point of claim 1, wherein the second backhaul link operates in primary multi-link operation (P-MLO) mode or asynchronous multi-link multi-radio (AMLMR) mode.

7. The first access point of claim 1, wherein after the switch to operate the second radio on the third channel within the second frequency band, the first access point and the second access point operate on independent channels, within the second frequency band, for fronthaul communication.

8. The first access point of claim 1, wherein:
the first radio used for the first backhaul link is also used for a first fronthaul link,
prior to the reconfiguration of the backhaul operation, the second radio used for the second backhaul link is also used for a second fronthaul link, and
after the reconfiguration of the backhaul operation, the second radio is dedicated for fronthaul communication.

9. The first access point of claim 1, wherein the first access point further communicates with the second access point via:
a third radio, of the plurality of radios, that operates on a fifth channel within a third frequency band, wherein the fifth channel within the third frequency band is used for a first fronthaul link, a fourth radio, of the plurality of radios, that operates on a sixth channel within a fourth frequency band, wherein the sixth channel within the fourth frequency band is used for a second fronthaul link, or a combination thereof.

10. The first access point of claim 9, wherein:
the first radio used for the first backhaul link is dedicated for backhaul communication, and the third radio used for the first fronthaul link and the fourth radio used for the second fronthaul link are dedicated for fronthaul communication,
prior to the reconfiguration of the backhaul operation, the second radio used for the second backhaul link is also used for a third fronthaul link, and
after the reconfiguration of the backhaul operation, the second radio is dedicated for fronthaul communication.

11. The first access point of claim 1, wherein:
the first access point is a controller access point and the second access point is an agent access point, or
the first access point is an agent access point and the second access point is a controller access point.

12. The first access point of claim 1, wherein:
the reconfiguration of the backhaul operation comprises a transition of the backhaul operation from a first quantity of backhaul links to a second quantity of backhaul links, and
the second quantity of backhaul links is less than the first quantity of backhaul links.

13. The first access point of claim 12, wherein the first quantity of backhaul links is equal to a maximum quantity of multi-link operation (MLO) links for a backhaul network associated with the first access point.

14. A second access point, comprising:
one or more memories storing processor-executable code; and
one or more processors coupled with the one or more memories and individually or collectively operable to execute the code to cause the second access point to:
communicate with a first access point via: a first backhaul link using a first radio, of a plurality of radios associated with the second access point, that operates on a first channel within a first frequency band, and a second backhaul link using a second radio, of the plurality of radios, that operates on a second channel within a second frequency band;
communicate, with the first access point, a backhaul link reconfiguration message based at least in part on expected backhaul traffic between the first access point and the second access point, and based at least in part on an expected data traffic load of one or more stations associated with the first access point, the second access point, or both, the backhaul link reconfiguration message including a first indication of a reconfiguration of a backhaul operation, a second indication of termination of the second backhaul link between the first access point and the second access point, and a third indication of a switch by the first access point to operate on a third channel within the second frequency band for fronthaul communication; and
receive, from the second access point and via the first backhaul link, a first backhaul message based at least in part on the backhaul link reconfiguration message.

15. The second access point of claim 14, wherein the one or more processors are individually or collectively further operable to execute the code to cause the second access point to:
transmit, to the first access point, a second backhaul message including link information, wherein the backhaul link reconfiguration message is communicated based at least in part on the link information.

16. The second access point of claim 14, wherein:
the backhaul link reconfiguration message further includes an indication a fourth channel within the second frequency band to use for fronthaul communication, and
the fourth channel is different from the third channel.

17. The second access point of claim 14, wherein termination of the second backhaul link between the first access point and the second access point is based at least in part on one or more of: overlapping basic service set (OBSS) interference associated with one or more links associated with the first access point satisfying an interference threshold, a channel condition associated with one or more links associated with the first access point satisfying a channel condition threshold, available airtime associated with one or more links associated with the first access point satisfying an available airtime threshold, or any combination thereof.

18. The second access point of claim 14, wherein the one or more processors are individually or collectively further operable to execute the code to cause the second access point to:
receive, from the first access point and based at least in part on a channel condition associated with the first backhaul link satisfying a channel condition threshold, a second backhaul link reconfiguration message indicating a second switch by the first access point to operate on the second channel within the second frequency band for backhaul communication.

19. The second access point of claim 14, wherein:
the second backhaul link operates in primary multi-link operation (P-MLO) mode or asynchronous multi-link multi-radio (AMLMR) mode.

20. The second access point of claim 14, wherein after the switch by the first access point to operate on the second channel within the second frequency band for fronthaul communication, the first access point and the second access point operate on independent channels, within the second frequency band, for fronthaul communication.

21. The second access point of claim 14, wherein:
the first radio used for the first backhaul link is also used for a first fronthaul link,
prior to the reconfiguration of the backhaul operation, the second radio used for the second backhaul link is also used for a second fronthaul link, and
after the reconfiguration of the backhaul operation, the second radio is dedicated for fronthaul communication.

22. The second access point of claim 14, wherein the second access point further communicates with the first access point via:
a third radio, of the plurality of radios, that operates on a fifth channel within a third frequency band, wherein the fifth channel within the third frequency band is used for a first fronthaul link,
a fourth radio, of the plurality of radios, that operates on a sixth channel within a fourth frequency band, wherein the sixth channel within the fourth frequency band is used for a second fronthaul link, or
a combination thereof.

23. The second access point of claim 22, wherein:
the first radio used for the first backhaul link is dedicated for backhaul communication, and the third radio used for the first fronthaul link and the fourth radio used for the second fronthaul link are dedicated for fronthaul communication,
prior to the reconfiguration of the backhaul operation, the second radio used for the second backhaul link is also used for a third fronthaul link, and
after the reconfiguration of the backhaul operation, the second radio is dedicated for fronthaul communication.

24. The second access point of claim 14, wherein:
the first access point is a controller access point and the second access point is an agent access point, or
the first access point is an agent access point and the second access point is a controller access point.

25. The second access point of claim 14, wherein:
the reconfiguration of the backhaul operation comprises a transition of the backhaul operation from a first quantity of backhaul links to a second quantity of backhaul links, and
the second quantity of backhaul links is less than the first quantity of backhaul links.

26. The second access point of claim 25, wherein the first quantity of backhaul links is equal to a maximum quantity of multi-link operation (MLO) links for a backhaul network associated with the second access point.

27. A method for wireless communications by a first access point, comprising:
communicating with a second access point via: a first backhaul link using a first radio, of a plurality of radios associated with the first access point, that operates on a first channel within a first frequency band, and a second backhaul link using a second radio, of the plurality of radios, that operates on a second channel within a second frequency band;
communicating, with the second access point, a backhaul link reconfiguration message indicating a reconfiguration of a backhaul operation based at least in part on expected backhaul traffic between the first access point and the second access point, and based at least in part on an expected data traffic load of one or more stations associated with the first access point, the second access point, or both,
the backhaul link reconfiguration message indicating termination of the second backhaul link between the first access point and the second access point, and
the backhaul link reconfiguration message indicating a switch by the first access point to operate the second radio on a third channel within the second frequency band for fronthaul communication; and
transmitting, to the second access point and via the first backhaul link, a first backhaul message based at least in part on the backhaul link reconfiguration message.

28. The method of claim 27, wherein:
the backhaul link reconfiguration message further includes an indication a fourth channel within the second frequency band to use for fronthaul communication, and
the fourth channel is different from the third channel.

29. A method for wireless communications by a second access point, comprising:
communicating with a first access point via: a first backhaul link using a first radio, of a plurality of radios associated with the second access point, that operates on a first channel within a first frequency band, and a second backhaul link using a second radio, of the plurality of radios, that operates on a second channel within a second frequency band;
communicating, with the first access point, a backhaul link reconfiguration message based at least in part on expected backhaul traffic between the first access point and the second access point, and based at least in part on an expected data traffic load of one or more stations associated with the first access point, the second access point, or both, the backhaul link reconfiguration message including a first indication of a reconfiguration of a backhaul operation, a second indication of termination of the second backhaul link between the first access point and the second access point, and a third indication of a switch by the first access point to operate on a third channel within the second frequency band for fronthaul communication; and
receiving, from the second access point and via the first backhaul link, a first backhaul message based at least in part on the backhaul link reconfiguration message.

30. The method of claim 29, wherein:
the backhaul link reconfiguration message further includes an indication a fourth channel within the second frequency band to use for fronthaul communication, and
the fourth channel is different from the third channel.
